(19) United States
(12) Patent Application Publication
(10) Pub. No.: US 2026/0304275 A1
(43) Pub. Date: Oct. 1, 2026

(54) SYSTEMS AND METHODS FOR CONTROLLING COMMUNICATIONS, POWER, AND COMPUTING

(71) Applicant: Anduril Industries, Inc., Costa Mesa, CA (US)

(72) Inventors: Peter Bynum, Jamaica Plain, MA (US); Michael Alan Breslow, Irvine, CA (US); Erik Christensen, Huntington Beach, CA (US); Anton Johannes De Winter, Long Beach, CA (US); Victor Manuel Franco, JR., Laguna Niguel, CA (US); Peter Goldsborough, Washington, DC (US); Jeremiah Sundoe Lee, Bellvue, WA (US); Ciaran Long, Drumcondra, Dublin (IE); Charles Feng MA, Irvine, CA (US); Cian Masterson, Loughshinny (IE); Gimin Moon, Woodinville, WA (US); Francis Murray, Dublin (IE); Sarah Molly North, Santa Ana, CA (US); Suwarna Poudel, Santa Ana, CA (US); Mark Ryan, Dublin (IE); Andrew C. Swanson, Seattle, WA (US); Michael Mong-kuan Tse, Kirkland, WA (US); David Tuttle, Alexandria, VA (US); Rishi Raj Verma, Aliso Viejo, CA (US); Phillip Tyler Williams, Costa Mesa, CA (US)

(21) Appl. No.: 19/446,057

(22) Filed: Jan. 12, 2026

Related U.S. Application Data
(60) Provisional application No. 63/781,079, filed on Mar. 31, 2025.

(51) Int. Cl. H04W 36/30

(52) U.S. Cl. CPC H04W 36/304

(57) ABSTRACT

Transportable and body-worn control and communication systems are disclosed. Approaches for configuring and maintaining network connectivity, providing a single user interface for control and operation, and modular design and interoperability of such systems are disclosed.

### CROSS-REFERENCE TO RELATED APPLICATIONS

This application claims priority to U.S. Provisional Patent Application No. 63/781,079 filed on Mar. 31, 2025, which is incorporated by reference in its entirety.

Any and all applications for which a foreign or domestic priority claim is identified in the Application Data Sheet as filed with the present application are hereby incorporated by reference under 37 CFR 1.57.

### BACKGROUND

Control and communication systems have become increasingly important in various aspects, including responsiveness, awareness, cooperative engagement, and distributed operations.

### BRIEF DESCRIPTION OF THE DRAWINGS

Implementations of various inventive features are described with reference to the following drawings. Throughout the drawings, reference numbers are re-used to indicate correspondence between referenced elements. The drawings are provided to illustrate example implementations described herein and are not intended to limit the scope of the disclosure.

FIG. 1 illustrates a block diagram of a computing system according to various implementations of the present disclosure.

FIG. 2 illustrates a block diagram of an example operational environment, according to various implementations of the present disclosure.

FIG. 3 illustrates a system diagram of a control and communications system, according to various implementations of the present disclosure.

FIG. 4 illustrates a system diagram for detection and characterization of network connections.

FIGS. 5 to 20 illustrate various user interface screens of operating a control and communications system, according to various implementations of the present disclosure.

FIG. 21 illustrates a block diagram of an example operational environment for remote monitoring and predictive maintenance, according to various implementations of the present disclosure.

FIGS. 22 to 29 illustrate various user interface screens for remote monitoring and predictive maintenance of a control and communications systems, according to various implementations of the present disclosure.

FIGS. 30 to 32 illustrate various views of a body-worn control and communications system, according to various implementations of the present disclosure.

FIG. 33 illustrates a system diagram of a body-worn control and communications system, according to various implementations of the present disclosure.

FIG. 34 illustrates an example operating environment of a body-worn control and communications system, according to various implementations of the present disclosure.

FIGS. 35 to 37 illustrate various network connectivity environments of a body-worn control and communications system, according to various implementations of the present disclosure.

### DETAILED DESCRIPTION

Although certain implementations and examples are disclosed below, inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process are optionally and variously performed in any suitable sequence and are not necessarily limited to any particular disclosed sequence. Various operations are described as multiple discrete operations in turn, in a manner that is helpful in understanding certain implementations; however, the order of description should not be construed to imply that these operations are order dependent. Additionally, the structures, systems, and/or devices described herein are optionally embodied as integrated components or as separate components. For purposes of comparing various implementations, certain aspects and advantages of these implementations are described. Not necessarily all such aspects or advantages are achieved by any particular implementation. Thus, for example, various implementations are carried out in a manner that achieves or optimizes one advantage or group of advantages as taught herein without necessarily achieving other aspects or advantages as also taught or suggested herein.

The present disclosure relates to control and communications systems. More specifically, aspects of the present disclosure relate to transportable control and communications systems as well as to approaches for configuring and maintaining network connectivity, providing a single user interface for operation and control, remote monitoring, and modular design and interoperability of such systems.

Control and communications systems are important for providing the capability for effective decision-making and tactical execution. Such systems (for instance Anduril Menace systems) can facilitate communication, information management, decision making, coordination, and command structure. Such control and communications systems can include, for example, a family of configurable and expeditionary control and communications systems designed to support distributed operations in austere environments. These systems can feature tightly integrated power, heating and cooling, redundant communications, and computing subsystems, and can provide a turn-key solution that can be adapted to different form factors based on capability and mobility requirements. Such self-contained design can simplify set up, increase reliability, and deliver control and communications capabilities once the power switch is turned on. Control and communications systems can be designed to operate in extended temperature ranges with minimal existing infrastructure, be easily transportable by standard transportation solutions (such as C-130 or equivalent aircraft), and minimize logistical burden by eliminating the need for special tooling or additional manpower to support.

Advantageously, the control and communications systems of the present disclosure can provide a single user interface to observe and control power, communications, climate and compute subsystems to ease operator (or user) cognitive load and maintenance burden. These systems, according to various implementations, support redundant and resilient communications and networking while supporting multiple communications capabilities across domains and distributed geographies. The systems can integrate various data links, communications capabilities, sensors, and effectors to deliver comprehensive mission support via various other communications, sensor, and data gathering systems (e.g., Anduril Lattice, as described herein).

In some implementations, control and communication systems's modular compute, communications, power, and thermal designs (such as those of Anduril Menace) are adapted to different form factors based on capability and mobility requirements to provide integrated control and communications solutions across strategic, operational, and tactical operations. For example, a portable, body-worn system can extend computing and communications functionality to an individual operator.

Any one or more aspects of any control and communications system described herein can be used as part of a command and control system or a command, control, communications, and computers system. Any one or more aspects of any control and communications system described herein can be used to communicate with a command and control system or a command, control, communications, and computers system.

Various combinations of the above and below recited features, embodiments, and aspects are also disclosed and contemplated by the present disclosure.

In various implementations, systems and/or computer systems are disclosed that comprise one or more computer-readable storage mediums or devices comprising, configured to store, and/or storing program instructions, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising one or more computer-readable storage mediums or devices, and/or one or more computer-readable storage mediums or devices, are disclosed, wherein the computer-readable storage mediums comprise, are configured to store, and/or store program instructions, the program instructions executable by one or more processors to cause the one or more processors to perform operations comprising one or more aspects of the above- and/or below-described implementations (including one or more aspects of the appended claims).

Various aspects of the disclosure will now be described with regard to certain examples and embodiments, which are intended to illustrate but not limit the disclosure. Although aspects of some embodiments described in the disclosure will focus, for the purpose of illustration, on particular examples of serving configurations, compute resource allocation, computing and communication resources, and optimization algorithms, the examples are illustrative only and are not intended to be limiting. In some embodiments, the techniques described herein may be applied to additional or alternative serving configurations, compute resource allocation, computing and communication resources, and optimization algorithms, and the like. Additionally, any feature used in any embodiment described herein may be used in any combination with any other feature or in any other embodiment, without limitation.

### Overview of Computing System and Other Systems

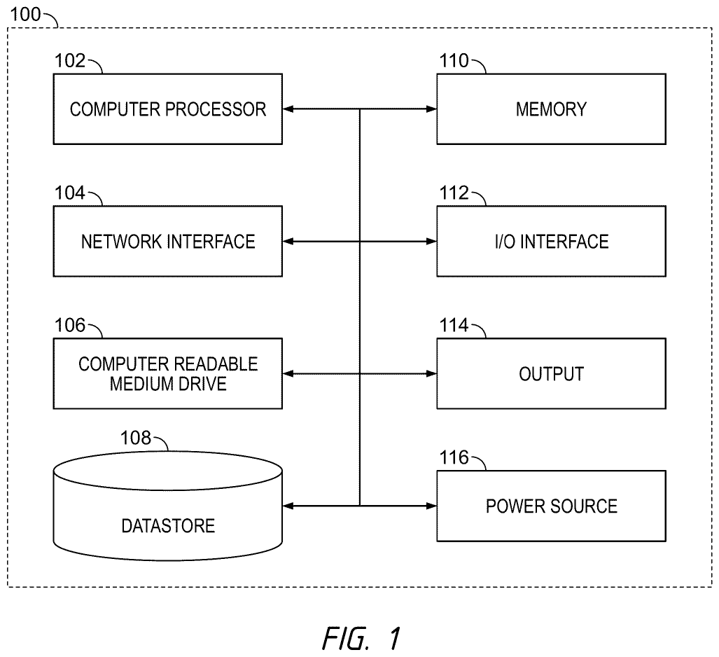

FIG. 1 illustrates various components of an example computing system 100 (sometimes referred to as computer system or computer). In some embodiments, as shown, the computer 100 may include: one or more computer processors 102, such as one or more physical central processing units (“CPUs”), graphics processing units (“GPUs”), or neural processing units (“NPUs”); one or more network interfaces 104, such as a network interface cards (“NICs”); one or more computer-readable medium drives 106, such as a high density disk (“HDDs”), solid state drives (“SSDs”), flash drives, and/or other persistent non-transitory computer-readable media; one or more datastore 108, such as physical storage and/or remote storage, and/or other data storage components; one or more computer-readable memories 110, such as random access memory (“RAM”) and/or other volatile non-transitory computer-readable media; one or more input/output interfaces 112, such as a serial interface and/or a parallel interface; one or more outputs 114, such as display and/or touch screen display; one or more power sources 116, such as external power and/or battery.

The computer-readable memory 110 may include computer program instructions that one or more computer processors 102 execute in order to implement one or more disclosed implementations. The computer-readable memory 110 can store an operating system that provides computer program instructions for use by the computer processor(s) 102 in the general administration and operation of the computer 100.

When a routine is initiated, a corresponding set of executable program instructions stored on a computer-readable medium drive 106 may be loaded into computer-readable memory 110 and executed by one or more computer processors 102. In some embodiments, a routine—or portions thereof—may be implemented on multiple computing devices and/or multiple processors, serially or in parallel.

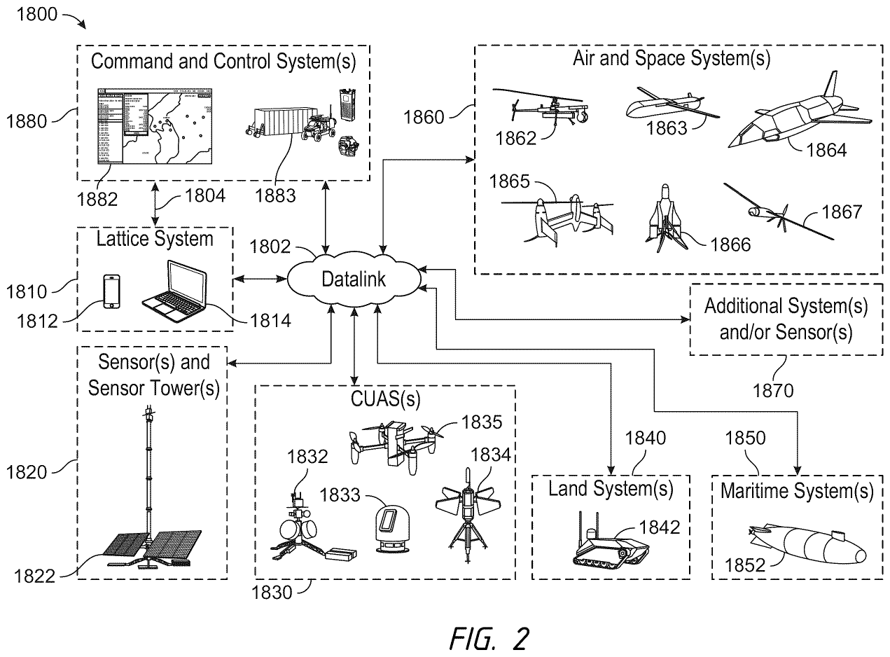

FIG. 2 illustrates a block diagram of an example operational environment 1800. The example operational environment 1800 includes vehicles such as land system(s) 1840, maritime system(s) 1850, air and/or space system(s) 1860, and/or counter unmanned arial system(s) 1830 (referred to herein as CUAS(s) 1830). As also illustrated, the operational environment 1800 can include one or more external computing devices such as a Lattice system 1810, control and communications system(s) 1880, and/or the like. As further illustrated, the operational environment 1800 can include data sources and/or sensors such as one or more sensor(s) and/or sensor tower(s) 1820, and/or CUAS(s) 1830. As also illustrated, the operational environment 1800 can include networks and/or datalinks such as network and/or datalink 1802 which can provide communications among the various components of the operational environment 1800. The operational environment 1800 can also include various direct and/or alternative communications links among various components, such as communications link 1804 between the Lattice system 1810 and the control and communications system 1880.

The groupings of components in the example operational environment 1800 illustrated in FIG. 2 and described above is illustrative and not limiting. For example, various components are organizable into groups different from those described above, and/or into multiple groups. For example, any of the various vehicles (e.g., land system 1840, maritime systems 1850, air and space systems 1860, space systems 1860) also include sensor and/or data source functionality by way of various sensors (e.g., cameras, radar devices, and/or any other sensors 110) included in or on those vehicles. Similarly, any of the various sensors (e.g., sensors and sensor towers 1820, CUASs 1830, and/or the like) optionally also comprise and/or be associated with vehicles. Further, the operational environment 1800 includes components different from those described in reference to FIG. 2, and/or additional system(s) (e.g., vehicles, computing systems, and/or the like) and/or sensor(s) 1870.

Sensors and sensor towers 1820 include, for example, a sentry tower 1822. Examples of such sensor towers and associated functionality are described in U.S. Patent Publication No. 2022/0377232, published Nov. 24, 2022, and titled “Auto-Focus Acquisition For Remote Flying Targets” (the '232 Publication), and U.S. Patent Publication No. 2022/0377242, published Nov. 24, 2022, and titled “Auto-Focus Tracking For Remote Flying Targets” (the '242 Publication), the entire disclosures of each of which are hereby made part of this specification as if set forth fully herein and incorporated by reference for all purposes, for all that they contain.

CUASs 1830 include, for example, a long range sentry tower 1832, a wide-area infrared system for persistent surveillance (WISP) 1833, a software-defined electromagnetic warfare (EW) device/system (e.g., a Pulsar system) 1834, and/or an autonomous counter unmanned arial system drone device (e.g., an Anvil device) 1835. CUASs 1830, in some cases, include various autonomous functionalities, such as movement, goal seeking, ISR, and/or the like. Examples of such Pulsar systems and associated functionality are described in PCT International Publication No. 2023/225417, published Nov. 23, 2023, and titled “Modular System For Detecting, Tracking, And Transmitting To Identified Objects” (the '417 Publication), the entire disclosure of which is hereby made part of this specification as if set forth fully herein and incorporated by reference for all purposes, for all that it contains. Examples of such Anvil devices and associated functionality are described in U.S. Patent Publication No. 2020/0363824, published Nov. 19, 2020, and titled “Counter Drone System” (the '824 Publication), the entire disclosure of which is hereby made part of this specification as if set forth fully herein and incorporated by reference for all purposes, for all that it contains.

Land systems 1840 include, for example, various land-based vehicles 1842, such as automobiles, tanks or other armored vehicles, all-terrain vehicles, and/or the like. Land systems 1840, in some cases, include various autonomous functionalities, such as movement, goal seeking, ISR, and/or the like.

Maritime systems 1850 include, for example, a boat, a ship, and/or a submarine 1852. Maritime systems 1850, in some cases, include various autonomous functionalities, such as movement, goal seeking, ISR, and/or the like.

Air and/or space systems 1860 include, for example, an extended-range unmanned aircraft system (UAS) 1862, an air-breathing autonomous air vehicle (AAV) 1863, a group 5 AAV 1864, a tandem rotor AAV 1865, a vertical take-off and landing (VTOL) AAV 1866, an autonomous launch effect 1867, an airplane, a balloon, a missile, a rocket, a satellite, and/or the like. Examples of such UASs and associated functionality are described in U.S. Patent Publication No. 2020/0126431, published Apr. 23, 2020, and titled “Ruggedized Autonomous Helicopter Platform” (the '431 Publication), the entire disclosure of which is hereby made part of this specification as if set forth fully herein and incorporated by reference for all purposes, for all that it contains. Examples of such tandem rotor AAVs and associated functionality are described in U.S. Patent Publication No. 2024/0262489, published Aug. 8, 2024, and titled “Dual Engine Vertical Take Off And Landing Collapsible Fixed Wing Aircraft” (the '489 Publication), the entire disclosure of which is hereby made part of this specification as if set forth fully herein and incorporated by reference for all purposes, for all that it contains. Examples of such autonomous launch effect and associated functionality are described in U.S. Pat. No. 9,545,991, issued Jan. 17, 2017, and titled “Aerial Vehicle With Deployable Components” (the '991 Patent), the entire disclosure of which is hereby made part of this specification as if set forth fully herein and incorporated by reference for all purposes, for all that it contains.

In various implementations, and as described above, various components of the operational environment 1800 advantageously include autonomous functionality. This means, for example, that submarine 1852 and/or VTOL AAV 1866 is able to operate and pursue mission objectives and/or tasks autonomously. Such components, in some cases, are also be able to autonomously coordinate with each other in pursuit of mission objectives and/or tasks.

In various implementations, various components of the operational environment 1800 include munitions capabilities. Such capabilities, in some cases, are used by these components in pursuit of mission objectives and/or tasks.

In various implementations, and as described above, various vehicles and systems of the operational environment 1800 include sensor, munitions, and/or other functionality specific to the types of vehicles or systems. For example, in some cases a submarine includes SONAR functionality, a UAS or AAV includes camera functionality, and a sensor tower includes radar functionality.

In some examples, the Lattice system 1810 comprises a software platform advantageously capable of being used for a variety of missions and industries. The Lattice system 1810 communicates with any type of sensor, network, and/or system, and receives, integrates, and/or sends data and/or communications. The Lattice system 1810 moves data received from the various systems with which it communicates into a single integration layer that uses AI, machine learning, and/or sensor and data processing techniques to, e.g., filter high-value information to users. The filtering and the functionality of the Lattice system 1810 advantageously enables quick reactions to the data by tasking other systems such as sensors, vehicles, or other assets within and via the platform itself. Communications among the Lattice system 1810 and various components of the operational environment 1800 (e.g., vehicles, sensors, system, networks, and/or the like) are provided via various networks and/or datalinks, and can include “mesh” type communications. Examples of such mesh and/or secure communications, and/or other functionality and/or operations of the Lattice system 1810, are described in U.S. Patent Publication No. 2019/0380032, published Dec. 12, 2019, and titled “Lattice Mesh” (the '032 Publication), the entire disclosure of which is hereby made part of this specification as if set forth fully herein and incorporated by reference for all purposes, for all that it contains.

The Lattice system 1810 provides various ways of presenting data and/or enabling user interactions. This includes, for example, various interactive graphical user interfaces provided via user devices such as smartphones 1812 and/or other computing devices 1814. Further examples of sensors, vehicles, and/or systems in the operational environment 1800, and/or operation of the Lattice system 1810, are described in U.S. Patent Publication No. 2020/0167059, published May 28, 2020, and titled “Interactive Virtual Interface” (the '059 Publication), and the '824 Publication, the entire disclosures of each of which are hereby made part of this specification as if set forth fully herein and incorporated by reference for all purposes, for all that they contain.

The control and communications system 1880 includes any existing and/or legacy systems for providing control and communications over, for example, various sensors, systems, and/or vehicles. These control and communications systems 1880 include various computer systems, user interfaces 1882, hardware and/or devices 1883, and/or the like. The Lattice system 1810 advantageously communicates with the control and communications system 1880 and integrates with the control and communications system 1880 to provide various of the functionality described herein. This includes, for example, communications and coordination with various sensors, systems, and/or vehicles, including execute missions and achieve operational objectives. These functionalities include provide instructions to various autonomous systems, and enabling various systems to communicate and coordinate with each other.

Various components of the operational environment 1800, according to various implementations, include computers 100 and/or other components and/or functionality of the present disclosure. For example, various of the CUASs 1830, land systems 1840, maritime systems 1850, air and space systems 1860, and control and communications systems 1880 each include computers 100. By way of the combination of the computer 100, each vehicle and/or system advantageously have functionality specific to that vehicle or system, or type of vehicle or system. Such functionality optionally includes, as described herein, receiving sensor and/or operational data, and executing controls to perform tasks and/or seek mission objectives, within the operational environment 1800.

Various components of the operational environment 1800, according to various implementations, include signal transmission and reception systems, object detection systems, and other related components and functionalities. For example, various of the CUASs 1830, land systems 1840, maritime systems 1850, and air and space systems 1860 each optionally include signal and detection management systems. In each case, these systems optionally include respective common and/or similar signal processing boards and application-specific boards. By combining the signal processing board with the application-specific board, each system advantageously performs functions tailored to its specific requirements or type. Such functionality optionally includes, as described herein, detecting objects, receiving sensor or communication data, processing these signals, and transmitting responses or commands to perform tasks and achieve operational objectives within the operational environment 1800.

The Integrated Visual Augmentation System (IVAS), Soldier Borne Mission Command (SBMC) system, control and communications systems, and/or other systems as described herein including the headset, heads-up display (HUD), body-worn computing devices, and/or the like, and according to various implementations, operate within the operational environment 1800 to enable the various functionality of these aspects. For example, the control and communications system comprises a headset and/or body-worn computing device of the Lattice system 1810. These components thus optionally operate as sensors and/or interactive devices for providing situational awareness and/or the various functionality described herein.

In various implementations, one or more aspects of the operational environment 1800 and/or other systems disclosed herein comprise, or are implemented in, a “virtual computing environment”. As used herein, the term “virtual computing environment” should be construed broadly to include, for example, computer-readable program instructions executed by one or more processors to implement one or more aspects of the modules and/or functionality described herein. Further, in this implementation, one or more services/modules/engines and/or the like, of the system are to be understood as comprising one or more rules engines of the virtual computing environment that, in response to inputs received by the virtual computing environment, execute rules and/or other program instructions to modify operation of the virtual computing environment. For example, a request received from the user computing device is to be understood as modifying operation of the virtual computing environment to cause the request access to a resource from the system. Such functionality optionally comprises a modification of the operation of the virtual computing environment in response to inputs and according to various rules. Other functionality implemented by the virtual computing environment (as described throughout this disclosure) optionally further comprises modifications of the operation of the virtual computing environment, for example, the operation of the virtual computing environment optionally changes depending on the information gathered by the system. Initial operation of the virtual computing environment is to be understood as an establishment of the virtual computing environment. In some implementations the virtual computing environment comprises one or more virtual machines, containers, and/or other types of emulations of computing systems or environments. In some implementations the virtual computing environment comprises a hosted computing environment that includes a collection of physical computing resources that are remotely accessible and are rapidly provisionable as needed (commonly referred to as “cloud” computing environment).

Implementing one or more aspects of the system as a virtual computing environment optionally advantageously enables executing different aspects or modules of the system on different computing devices or processors, which increases the scalability of the system. Implementing one or more aspects of the system as a virtual computing environment optionally further advantageously enables sandboxing various aspects, data, or services/modules of the system from one another, which increases security of the system by preventing, e.g., malicious intrusion into the system from spreading. Implementing one or more aspects of the system as a virtual computing environment optionally further advantageously enables parallel execution of various aspects or modules of the system, which increases the scalability of the system. Implementing one or more aspects of the system as a virtual computing environment optionally further advantageously enables rapid provisioning (or de-provisioning) of computing resources to the system, which increases scalability of the system by, e.g., expanding computing resources available to the system or duplicating operation of the system on multiple computing resources. For example, in some cases the system is usable by thousands, hundreds of thousands, or even millions of users simultaneously, and many megabytes, gigabytes, or terabytes (or more) of data are transferred or processed by the system, and scalability of the system enables such operation in an efficient and/or uninterrupted manner.

### System Architecture

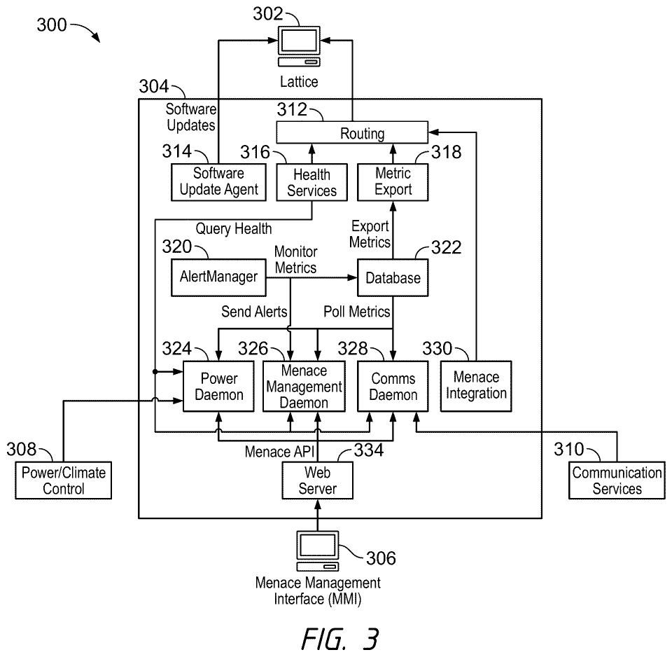

FIG. 3 illustrates a system diagram 300 of a control and communications system. The system diagram 300 illustrates a computing system 304 that can manage the control and communications system, a computing system 302 that communicates with Lattice (such as the Lattice system 1810), a computing system 306 that can provide a user interface for managing or operating the control and communications system (such user interface can be referred to as Menace Management Interface (MMI)), one or more power or climate control systems 308 that provide power to the control and communications system or its components, and one or more communication services 310 (sometimes referred to as communication links, network connections, or network links). The computing system 304 can communicate with the computing system 302 (which can run Lattice software) and computing system 306 (which can run MMI software).

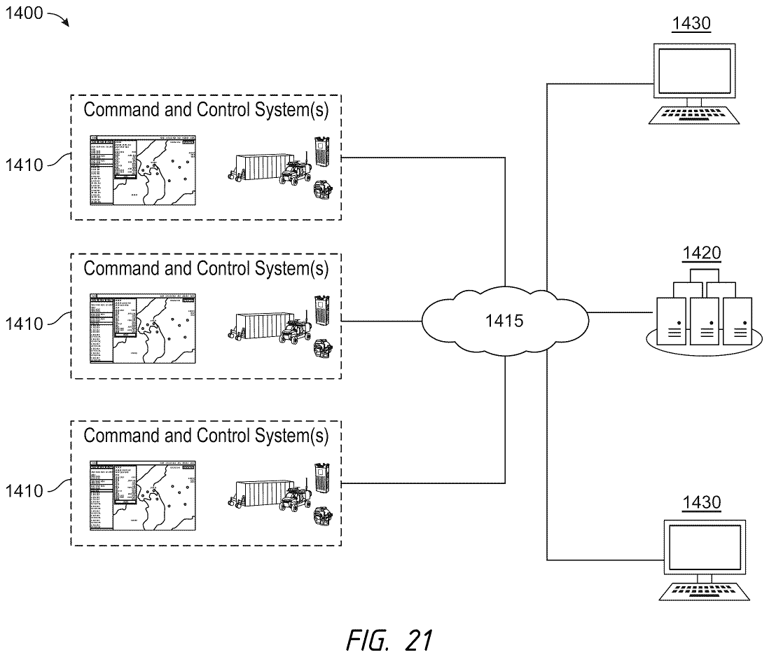

The computing system 304 can implement a plurality of services illustrated in box 304 of FIG. 3. Routing layer 312 can provide secure communication with the computing system 302 (which can run Lattice software) and may be used by other services as shown. Routing layer 312 can provide secure communication with one or more remote computing systems, such as 1810 illustrated in FIG. 2 or 1420 illustrated in FIG. 21. In some implementations, routing layer 312 provides a secure mesh networking infrastructure designed to work over a variety of networks and topologies and enable secure, resilient, and dynamic communications across distributed systems. Routing layer 312 supports, among others, encrypted communications between distributed systems, unique asset identification, real-time messaging across distributed systems, and configuration/state management of distributed systems. Routing layer 312 can act as a robust, flexible, and reliable message bus for scalable, high-performance, and secure communications across diverse network environments. Routing layer 312 can be modular, extensible, scalable, and flexible.

Software update agent 314 can communicate with the computing system 302 for the purpose of updating the software or firmware of the control and communications system. Health service 316 can provide to the computing system 302 information regarding the health of the control and communications system. Metrics export 318 can facilitate the collection and communication of various metrics, logs, or other data stored in a database 322 to the computing system 302. Such information can be stored in the database 322, which can be a timeseries database. The database can store information in temporal or chronological order, and the information can be accessed via the MMI. Alert manager service 320 can monitor metrics, logs, or other data and store relevant information in the database 322. For example, alert manager 320 stores metrics, logs, or other data associated with one or more alerts in the database 322 and generate one or more alerts, as described herein.

Power and climate daemon 324 can communicate with one or more power or climate control systems 308 to obtain status, health, or other information. Communication can be accomplished using one or more of serial, Controller Area Network (CAN), Ethernet (LAN/WLAN), or the like protocols or interfaces. In some cases, power and climate daemon 324 may be able to automatically detect or control one or more power or climate control systems 308 (such as via an API). Depending on the form factor, the control and communications system or one of its components can be powered by one or more power systems, which can include primary and auxiliary power sources. FIG. 3 illustrates the following power or climate control systems 308: IHP, batteries, Synqor, environmental control units (ECU), BB-2590 battery pack (which can be used for powering tactical radios), generator (such as fuel generator), external power (sometimes referred to as shore power), or Comrod. In some instances, multiple instances of any of the illustrated power or climate control systems 308 can be present. In some implementations, one or more of the illustrated power systems 308 may not be present or additional or alternative power systems may be used.

Power sources can be different depending on the form factor. For instance, a large control and communications system is powered by external power, generator, or battery. As another example, an expeditionary control and communications system is be powered by external power, vehicle alternator, or battery. As yet another example, a body-worn control and communications system is be powered by external power or battery.

Management daemon 326 can generate and provide information for the MMI. Management daemon 326 can communicate with other services, such as power and climate daemon 324 and communications daemon 328 to obtain information regarding power management and communication links for output on the MMI. Depending on the form factor, different services can be used to provide information to the management daemon 326 for output on the MMI.

Web server 334 can provide and interface between the management daemon 326 and the computing system 306 to provide information for output on the MMI and service user requests received via the MMI. MMI can display user interfaces that resemble web-based graphical user interfaces (such as web pages).

Communications daemon 328 can communicate with one or more network links, such as one or more satellite or terrestrial communications 310. Depending on the form factor, different network links may be available, such as geostationary Earth orbit (GEO) satellite, low Earth orbit (LEO) satellite, proliferated low Earth orbit (pLEO), cellular, Ethernet, or commercial and/or military radio. Communications daemon 328 may be able to automatically detect or control at least some of the communication links 310 (for instance, via an API).

Control and communications system can automatically recognize a network connection. For instance, an Ethernet connection is plugged into a port of the computing system 304 and is automatically detected by the communications daemon 328.

Integration 330 can interact with the computing system 302 to provide information regarding operation of the control and communications system. Integration 330 can publish an entity accessible by the computing system 302, and that entity can have one or more fields providing information regarding the operation of the control and communications system (such as battery charge level).

Information regarding the operation of the control and communications system can be provided via the MMI or uploaded to an external computing system (such as the Lattice system 1810) to facilitate remote monitoring and predictive maintenance.

Services being executed by the computing system 304 can be implemented as a software defined system that provides flexibility and facilitates, among others, rapid integration of different hardware components and devices.

### Connection Detection and Configuration

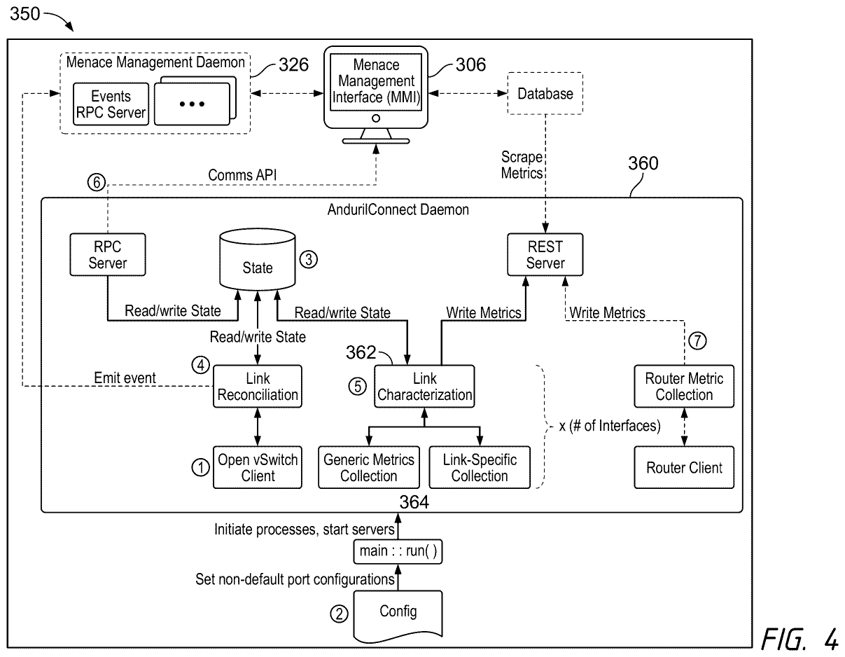

FIG. 4 illustrates a system diagram 350 illustrating automatic detection and characterization of network connections performed by the control and communications system. In some instances, automatic detection and characterization can be performed by a connection daemon 360 implemented by the computing system 304. Advantageously, these features reduce the operator's burden of configuring and managing network connections.

A new network connection can be added, for instance, by plugging in a wire to a port of the computing system 304, adding a network interface controller (NIC), or establishing a wireless connection with a hardware component of the computing system 304. As is illustrated at 362, the network connection can be characterized by examining the Media Access Control (MAC) address assigned to the NIC associated with the network connection or to a device with which the network connection is established to determine whether the MAC address matches any known MAC address (which can be stored in the database). Matching can be performed by examining the first six characters of the MAC address to determine the manufacturer or examining the last six characters of the MAC address, which uniquely identify the device. If the MAC address matches any known MAC address, this would allow the network connection to be characterized and, if applicable, automatically configured. For instance, suppose that a radio is plugged into an Ethernet port or connected wirelessly and the radio's MAC address is recognized. The control and communications system can perform one or more actions with the radio, such as activate the antennas. Network connection characterization can be similarly performed by examining an IP address assigned to the network connection (for instance, automatically via the Dynamic Host Configuration Protocol (DHCP) automatically or statically).

If the network connection has been characterized successfully, the connection can be monitored by collecting one or more network performance metrics described herein as shown at 364. To not degrade the user experience or unduly interfere with normal operation (such as by taking up too much bandwidth), connection monitoring can be performed periodically. For instance, monitoring entails collecting network performance metric(s) by periodically connecting to one or more known servers or other nodes.

Successful characterization of the network connection can allow control of the device through feature(s) exposed on a user interface (such as the MMI). For example, a Starlink or Starshield terminal available from SpaceX is stowed for travel or storage by making a selection on the user interface. As another example, the device can be turned off or otherwise muted for emissions control (EMCOM), as described herein.

The connection daemon 360 can be implemented as a software defined system that provides flexibility and facilitates, among others, rapid integration of different network connections and devices, collecting network performance metrics, and performing failover. The architecture can be connection-agnostic and can detect and characterize any type of connection responsive to receiving the connection being added (such as responsive to a network cable being plugged in).

### User Interface

MMI user interface can be designed to provide information regarding operation of the control and communications system and facilitate operation of the control and communications system while easing operator's cognitive load and maintenance burden. MMI can provide a plurality of screens (such as graphical user interface (GUI) screens) that can be displayed by the computing system 306, as described herein. In some instances, the plurality of screens can be displayed by another computing system, such as the computing system 304. While disclosed examples relate to displaying information on the MMI, other forms of output can be additionally or alternatively used, such as audio or tactile.

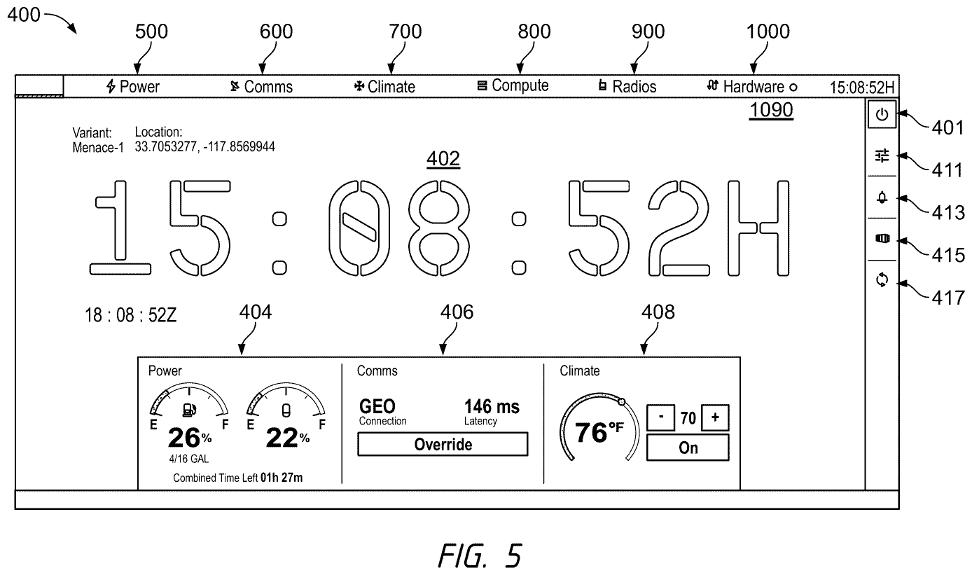

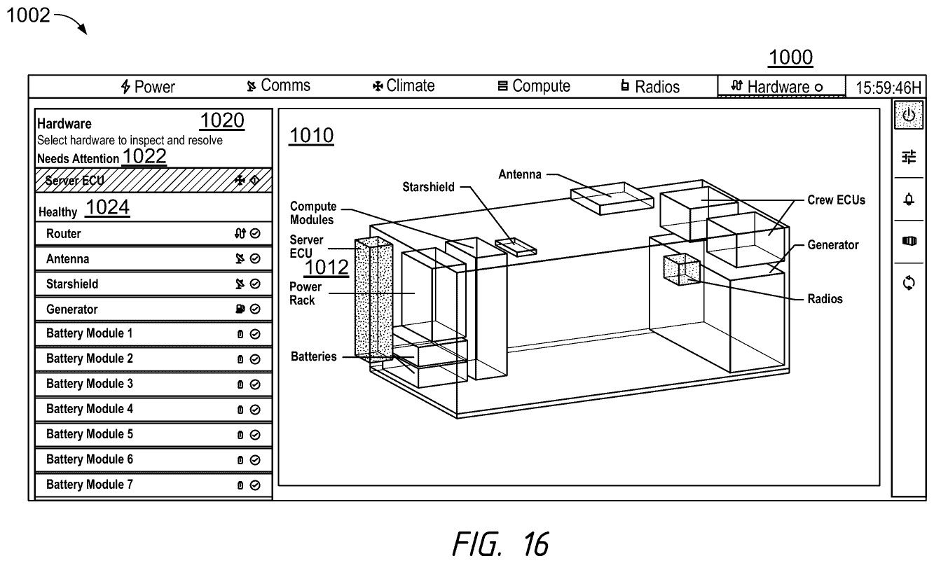

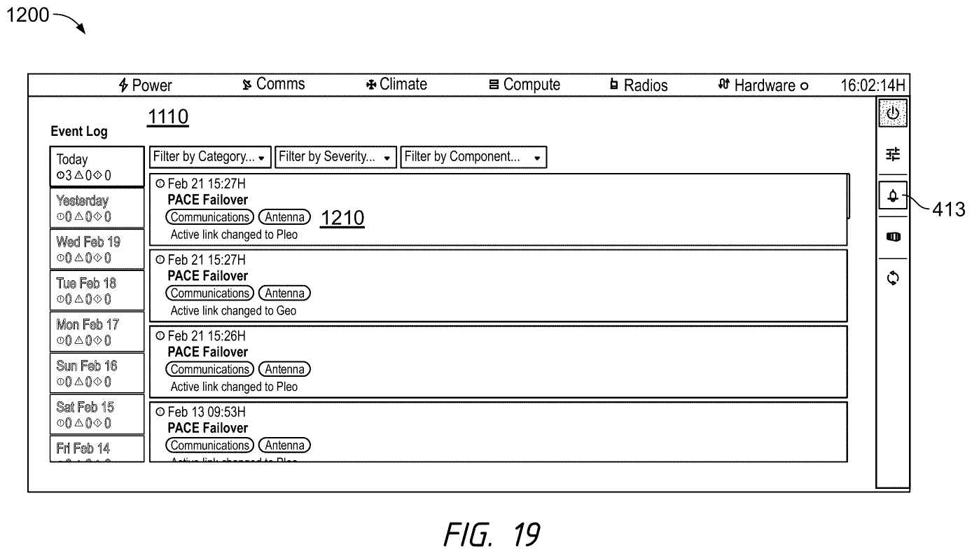

FIG. 5 illustrates a main screen 400 of the MMI. The main screen 400 can show the following information: current time 402, power system(s) status, network link(s) status, and ECU status. The main screen 400 can include one or more tabs for providing more detailed information regarding one or more of: power 500, communications 600, climate 700, computing resources 800, radios 900, or hardware 1000. The main screen can include one or more controls (illustrated as buttons), such as on/off control 401 that can power down the control and communications system, display preferences control 411 that can set various options, such as unit preferences (imperial or metric) or time preferences (local or UTC), event log control 413 that can display events (see FIG. 19), a digital twin view control 415 that graphically depicts the location of hardware components (see FIG. 16), and a display refresh control 417 that refreshes the MMI.

A red dot 1090 (or another indicator) below the tab hardware 1000 indicates that at least one hardware component is not operating correctly, as described herein. This can advantageously direct the operator's attention to this problem. The main screen 400 can include various widgets that may correspond to the various tabs of information. Such widgets may include, for example, power widget 404, communications widget 406, and/or climate widget 408.

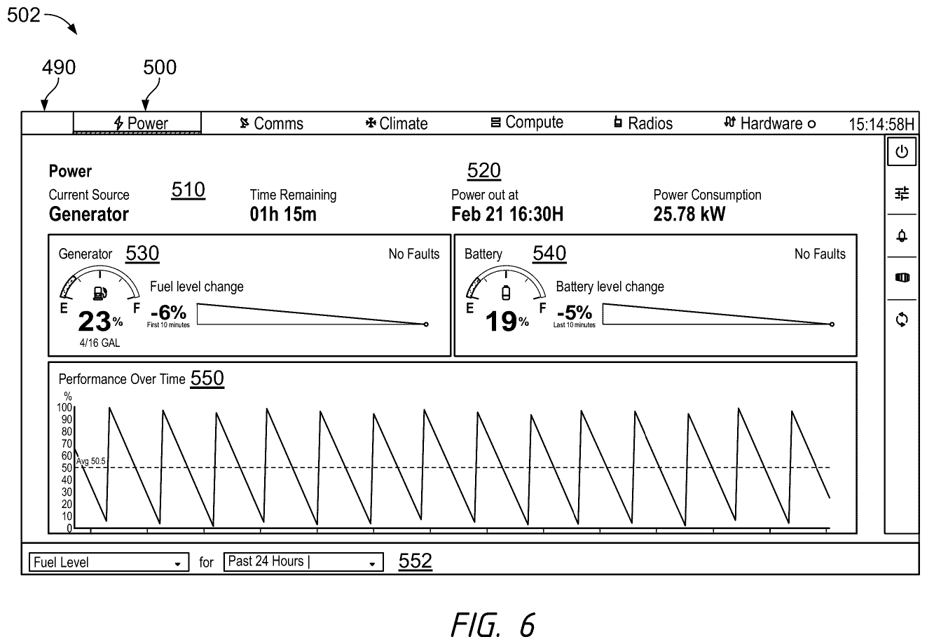

FIG. 6 illustrates a power screen 502 that can be accessed from the main screen 400 through the tab 500. The power screen 502 shows the status of one or more power sources. As is illustrated at 510, the control and communications system is being currently powered by a generator which has 1:15 hours of remaining capacity and will cease to provide power at 16:30 (as shown at 520). The generator has 23% fuel remaining as is shown at 530. The battery, which may be a backup power source, has 19% remaining capacity as shown at 540. Performance graph 550 illustrates power metric(s) over time, such as fuel level variation over past 24 hours. Different metrics (such as power consumption or battery charge) and time periods can be selected via drop down menus 552. As is described herein, the information displayed by the performance graph 550 can be stored and retrieved from the database 322.

Automatic switching to a backup power source can be supported. For instance, the control and communications system will switch to the backup power source (such as the battery) when the fuel generator is no longer able to provide sufficient power.

Automated shutdown can be supported. For example, suppose that that battery charge satisfies a threshold (such as 10-15%), the operator is notified that the power source is low, and the control and communications system can be automatically shut down so that the system does not get into an undefined state. When power is recovered, the system can automatically come up. For instance, the system comes up when external power is connected.

The power screen 502 (and any of the other screens described in this section) can include a tab 490 for accessing the main screen 400.

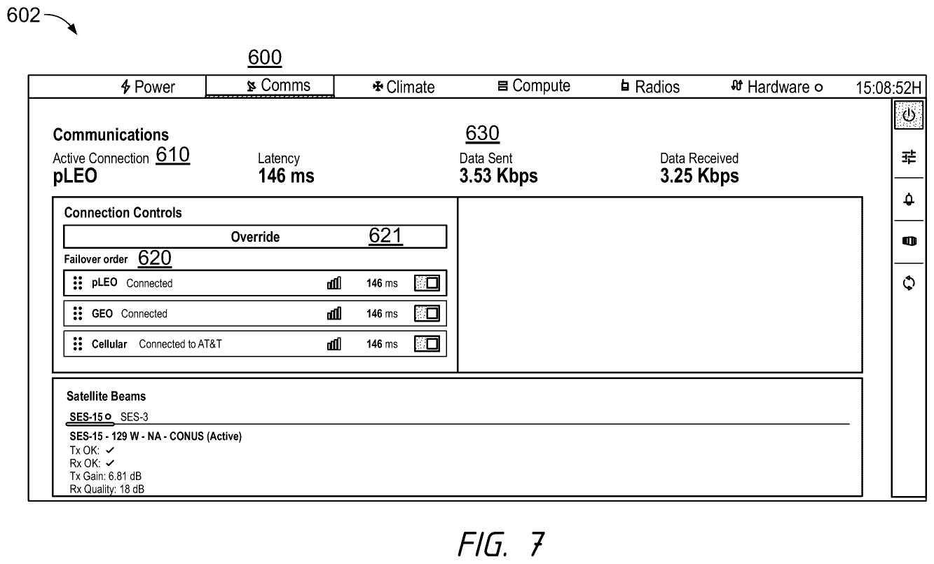

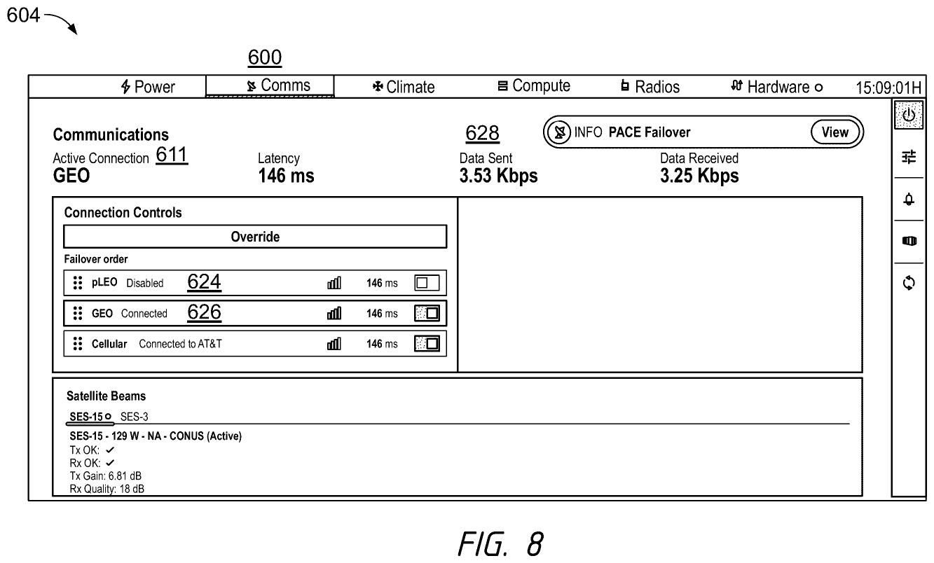

FIG. 7 illustrates a communications screen 602 that can be accessed from the main screen 400 through the tab 600. Communications screen 602 shows the status of one or more network connections. Three network connections are shown: pLEO (such as Stralink/Starshield), GEO, and cellular with the active connection being pLEO as shown at 610. As described in more in the section titled “Connection Failover,” AutoPACE functionality can be implemented by which automatic (or, in some cases, manual) determination of the optimal connection failover order (or PACE order) of the network connections is performed, PACE order is set, network connections are monitored, and fail over is performed as needed. As is illustrated at 620, the network connections can be arranged in the order of priority with pLEO connection being set as a primary connection, GEO being set as a contingent connection (or secondary connection), and cellular being set as an emergency connection. The order can be determined automatically or selected by the operator through the screen 602. The arrangement can represent failover order when the active connection is no longer satisfactory (such as when the link quality is below a quality threshold). For instance, as is illustrated by the communications screen 604 in FIG. 8, when the primary connection 622 (such as pLEO) is determined to be unsatisfactory, communication can be automatically switched to the contingent connection 624 (such as GEO), as indicated at 611. The operator can be notified of the switching by a message 628. When the primary connection recovers and becomes satisfactory again, communication can be switched back to the primary connection.

The communications screen 602 includes an override option 621 for the operator to override any automatic selection of a network connection. When the override option 621 is selected, communication can continue over the active connection (such as the primary connection) even when such connection is deemed to be no longer satisfactory. Selecting the override option 621 can allow the operator to manually select a network connection to be the active connection.

The communications screen 602 illustrates at 630 one or more statistics or network performance metrics of the network connections, such as latency, upload speed (or data rate), and download speed. Monitoring the network connections and failover are described herein. In some cases, when the override option 621 is selected, monitoring of the one or more statistics or network performance metrics of the network connections is suspended.

The control and communications system can provide wireless network access (WiFi), which can be configured and activated through the communications screen 602, but is not shown. WiFi can connect to the Internet via the active connection.

Although not shown in FIG. 7, the communications screen 602 can include a performance graph, similar to that described in FIG. 6. The performance graph can illustrate network performance metrics over a period of time, such as latency, data rate (upload or download), and signal strength.

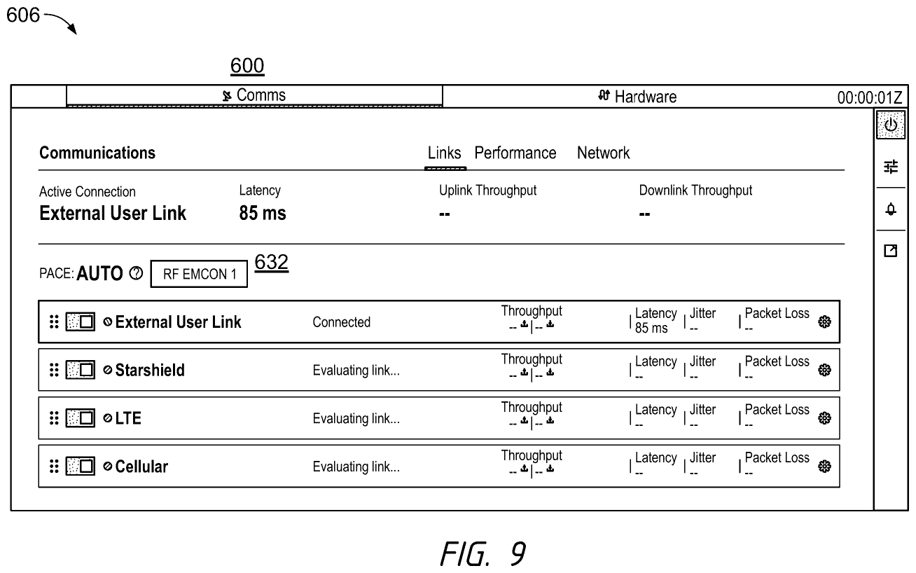

FIG. 9 illustrates a communications screen 606 that shows the status of electromagnetic (EM) emissions control (EMCOM). Normal operation associated with lowest, least restrictive level of EM emissions control (EMCOM 1 or delta) as selected at 632. At this level, all network connections are on and permitted to operate as normal.

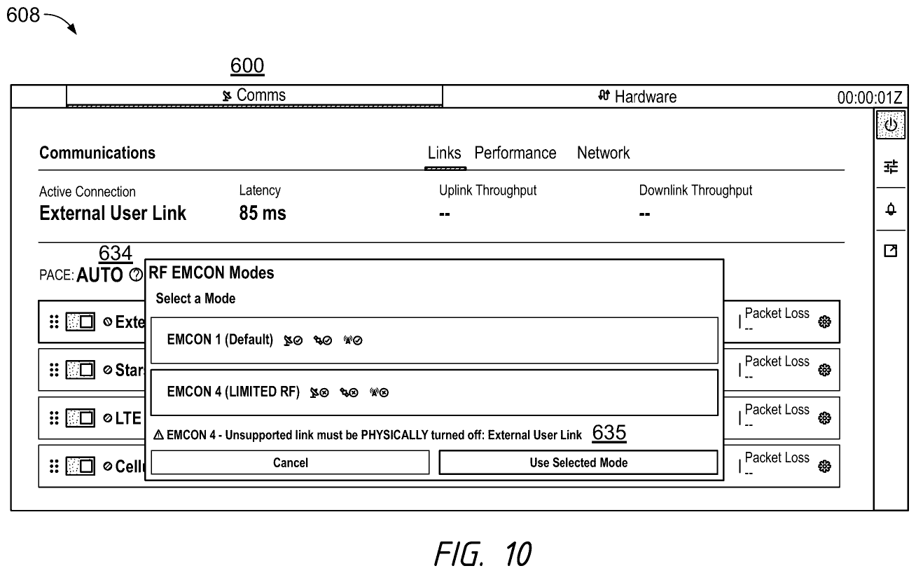

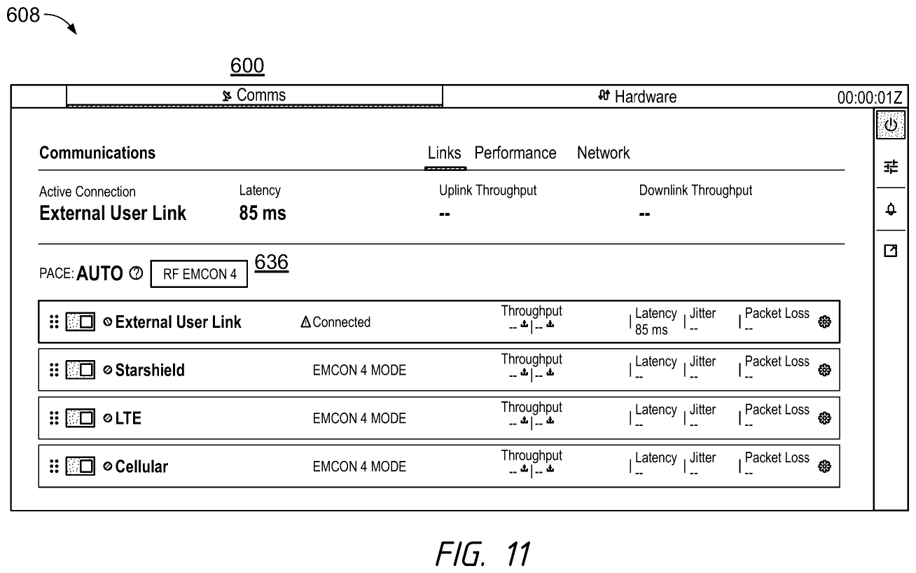

EMCOM level can be adjusted via the MMI, as shown at 634 in FIG. 10. The operator can select the highest, most restrictive level of EM emissions control (EMCOM 4 or alpha). At this level, all network connections or network devices would be turned off (or muted as much as possible). Network connections or network devices that have been automatically detected can be controlled, for instance, via the MMI by the connection daemon 360 or the power and climate daemon 324, as described herein. Such network connections or network devices can be automatically disabled (or muted) or its power source can be turned off. For example, the connection daemon 360 turns off a network device with which the particular network connection is established. As another example, the power daemon can turn off a power source that provides power the network device or network connection. Any network connections or network devices that have not been automatically detected (such as “External User Link”) would need to be turned off (or muted) by the operator as noted by the message 635. FIG. 11 illustrates a communication screen 608 displayed after EMCOM 4 has been selected, as shown at 636.

Although not illustrated, other EMCOM levels between levels 1 and 4 can be supported. These EMCOM levels can be more restrictive than EMCOM 1, but less restrictive than EMCOM 4. For instance, transmission over selected network connections/devices is permitted or network connections/devices operates in receive only mode.

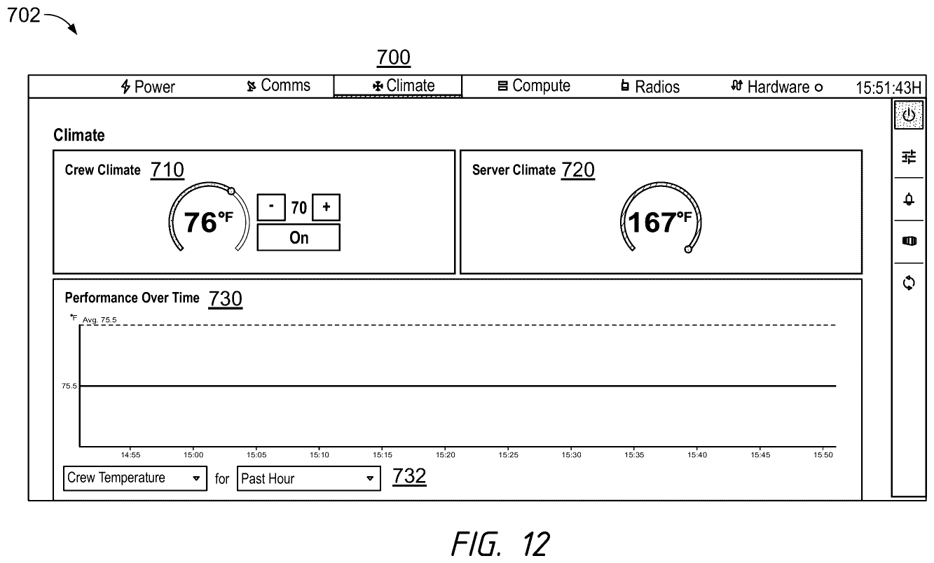

FIG. 12 illustrates a climate control screen 702 that shows the status of the climate control system(s) or ECU(s). The climate control screen 702 can be accessed from the main screen 400 through the tab 700. Certain control and communications systems that have one or more enclosures that house the operator(s) or hardware component(s) can include ECU(s) and the MMI for such systems can include the climate control tab and screen. MMIs for control and communications system that do not have one or more enclosures would not include the climate control tab and screen.

The climate control screen 702 illustrates at 710 the current temperature of the enclosure for the operator(s) (or crew). This temperature can be adjusted as is illustrated. The climate control screen 702 illustrates at 720 the current temperature in the enclosure housing one or more computing systems. The particular control and communications system can have two ECUs controlling the temperature in the enclosure for the operator(s) and the enclosure for the one or more computing systems.

Performance graph 730 illustrates climate metric(s) over time. Different metrics (such as crew temperature or server temperature) and time periods can be selected via drop down menus 732. As is described herein, the information displayed by the performance graph 730 can be stored and retrieved from the database 322.

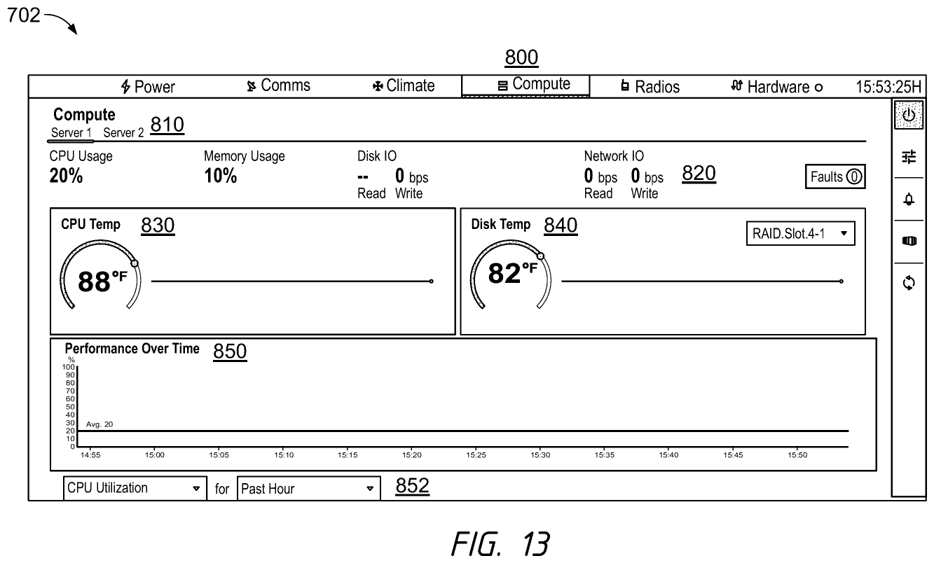

FIG. 13 illustrates a compute screen 802 that shows the status of various computing systems of the control and communications system. The compute screen 802 can be accessed from the main screen 400 through the tab 800. The compute screen 802 illustrates at 810 that two servers whose metrics are available are present. As shown at 820, the metrics include CPU utilization, memory usage, disk read/write speed, network download/upload speed, CPU temperature, and disk temperature. Also illustrated are metrics for the CPU temperature (830) and disk temperature (840). These metrics can be obtained from a motherboard of the server, for instance, via an API and stored in the database 322.

Performance graph 850 illustrates compute metric(s) over time. Different metrics (such as CPU utilization, memory utilization, etc.) and time periods can be selected via drop down menus 852. As is described herein, the information displayed by the performance graph 850 can be stored and retrieved from the database 322.

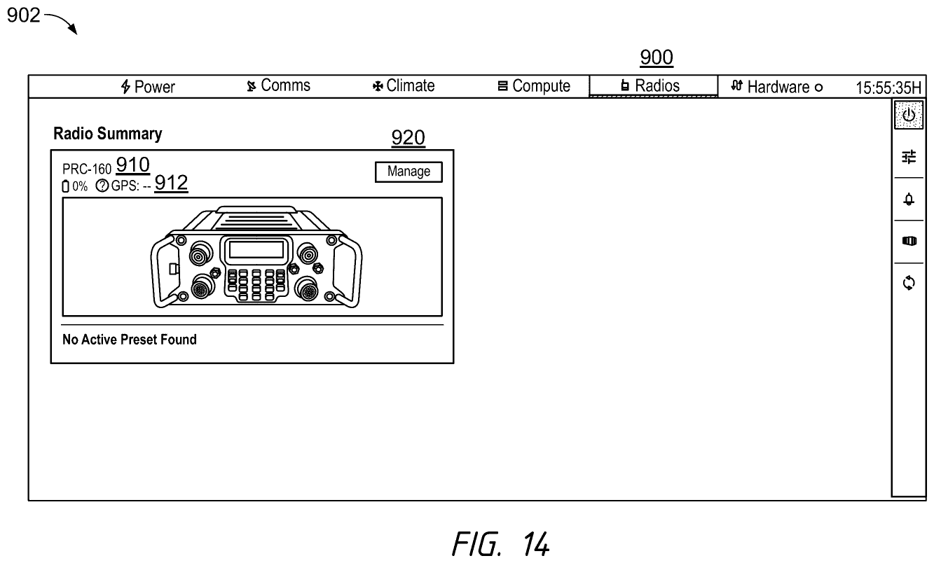

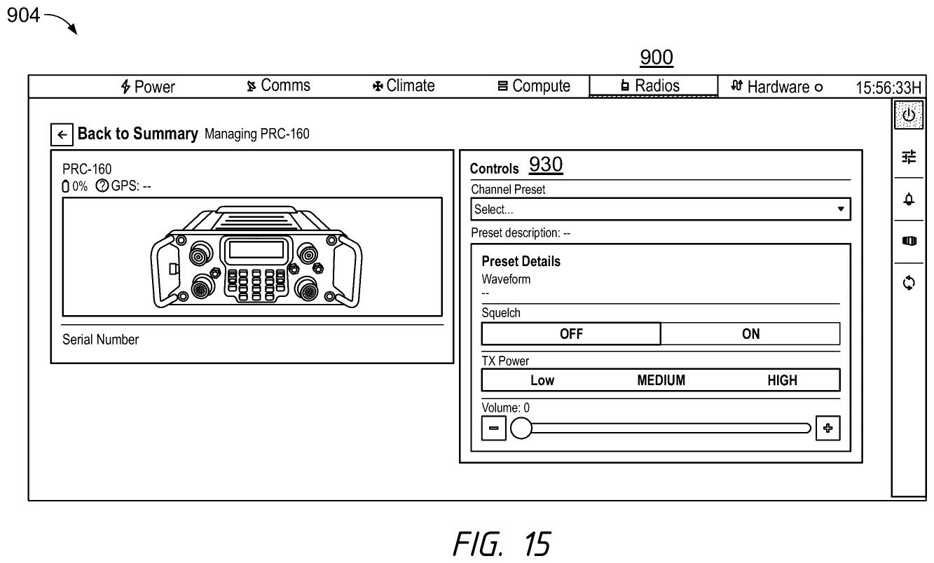

FIG. 14 illustrates a radio summary screen 902 that shows the status of one or more radios connected to the control and communications system (for instance, via one or more USB connections). The radio summary screen 902 can be accessed from the main screen 400 through the tab 900. The radio summary screen 902 illustrates at 910 that PRC-160 radio is connected and shows various metrics of the radio at 912, such as the battery status and GPS status. The operator can configure the radio by selecting option 920, which results in transition to the manage radio screen 904 illustrated in FIG. 15.

As is shown in manage radio screen 904, one or more parameters of the radio can be modified at 930. The user interface would allow the operator to modify the radio settings without being directly in front of the radio user interface and without using the radio user interface, which can be quite cumbersome. The user interface would allow the operator to, for instance, communicate via the radio while wearing the same headset for control and communications that is not plugged into the radio.

FIG. 16 illustrates a hardware screen 1002 that shows the health status of one or more hardware components of the control and communications system. The hardware screen 1002 can be accessed from the main screen 400 through the tab 1000. Health status of various hardware components and their locations is shown visually at 1010 (as a digital twin) and as a list at 1020. Hardware components can expose various metrics that can be processed by the alert manager 320, which can compare the metrics to various thresholds and generate one or more alerts in response to determining that one or more faults are present as a result of the one or more thresholds being satisfied. Any detected faults can be stored in the database 322.

To quickly draw the operator's attention to any problems, different colors or groupings can be used to illustrate health status. For instance, hardware components whose health status is determined to be normal are shown in green and hardware components whose health status is determined be abnormal are shown in red. The list view 1020 can separate components that are operating abnormally and normally into two distinct categories 1022 and 1024 as shown. With reference to FIG. 16, server ECU is shown in red at 1012 in the visual view 1010 and in red at 1022 in the list view 1020 thereby indicating that one or more faults have been detected for this hardware component.

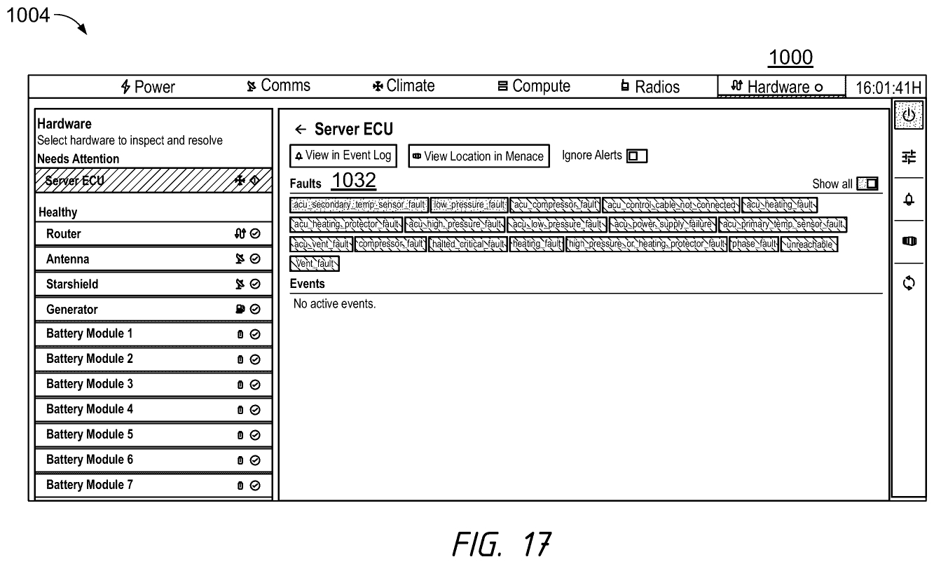

Selecting a component with an active fault, such as the server ECU, in the visual view 1010 or the list view 1024 (such as by clicking) can bring up the screen 1004 shown in FIG. 17, which can provide more details about the fault. Metrics being tracked for the server ECU can be listed at 1032 with one or more metrics generating the fault being listed in red, while other metrics are listed in green. As is illustrated, a temperature sensor and low pressure have triggered the fault.

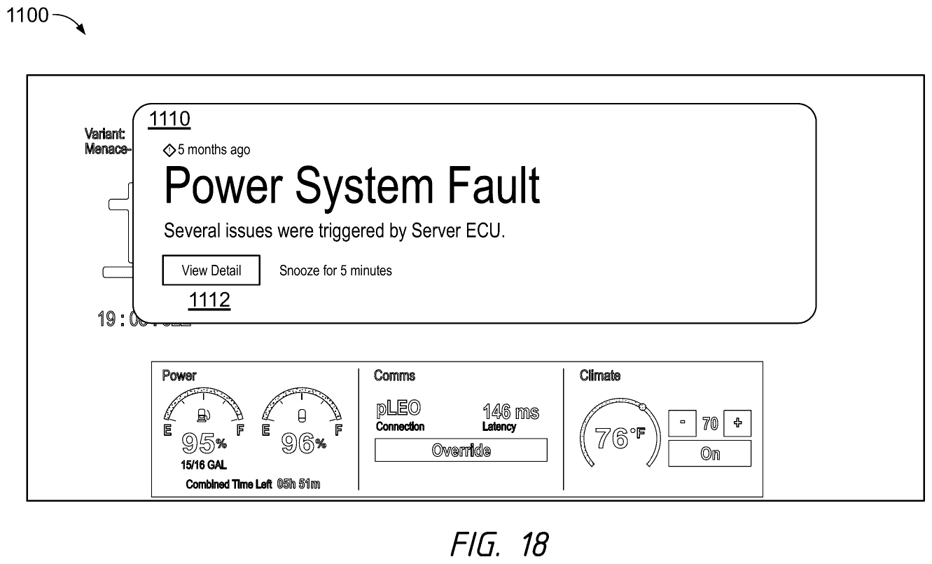

MMI can transition to sleep mode at operator's request or after passage of time (such as passage of time duration during which no operator activity has been detected). FIG. 18 illustrates a sleep mode screen 1100 (sometimes referred to as lock screen). The sleep mode screen 1100 can illustrate any detected faults, such as the server ECU fault shown at 1110. The sleep mode screen 1100 can be shown in a different color (such as red) when fault has been detected. Advantageously, this will facilitate gaining operator's attention to the fault and provide the operator with easy access to information related to the fault. For example, control 1112 causes transition to screen 1002 or 1004. The operator can transition from the sleep mode screen 1100 (such as to the main screen 400) responsive to providing one or more security credentials or manipulating the user interface.

FIG. 19 illustrates an event log screen 1200, which can be accessed by selecting the control 413. The event log screen 1200 can provide options for filtering the logged events (which can be stored in the database 322) by time, category, severity, or component. For instance, the event log provides information 1210 regarding occurrence(s) of failover. Such information can include time at which failover has occurred and an identification of an active connection as a result of failover. Such information 1210 can be added to an event log, which can be stored in the database 322, when failover occurs.

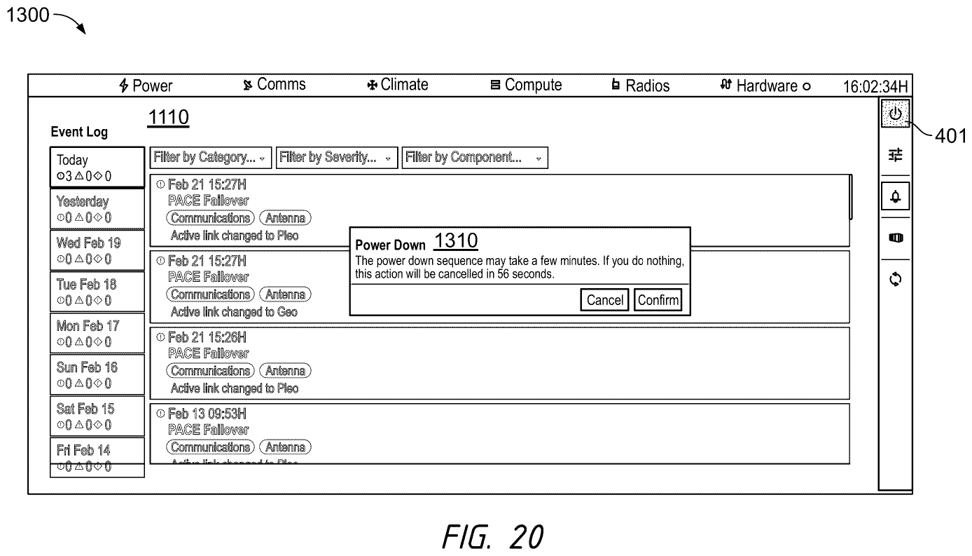

FIG. 20 illustrates a shutdown screen 1300, which can be displayed as a result of selecting control 401. The shutdown screen 1300 can be displayed when the control and communications system is being shut down. A message 1310 can be displayed notifying the operator of the system being shut down. The operator can cancel or confirm the shut down. In some cases, if the operator does not confirm the shutdown during a threshold duration of time following selection of the control 401 (such as 1 minute), shutdown is canceled.

### Connection Failover

As described herein, the control and communications system can perform automatic monitoring and failover of network connections (or AutoPACE). This can be performed by the connect daemon 360. With reference to FIG. 7, the failover order 620 can be automatically or manually selected by the operator. Three available network connections are shown: pLEO, GEO, and cellular. As is illustrated at 620, these network connections can be arranged in the order of priority with pLEO connection being set as the primary connection, GEO being set as the contingent connection, and cellular being set as the emergency connection. The failover order can be automatically selected, for instance, based on scoring one or more network performance metrics as described herein. Automatic selection can be performed periodically resulting in periodic updates of the failover order.

Each of the network connections can be monitored to assess the quality of the connections. Monitoring can entail collecting one or more network performance metrics, such as latency, packet loss, jitter, download throughput, and upload throughput. Monitoring can be performed periodically (such as at recurring intervals) so that it does not unduly interfere with normal operation. Monitoring can involve communicating with a known endpoint or node on the network and running one or more tests (such as sending one or more pings) to obtain the one or more network performance metrics.

Once the one or more network performance metrics have been obtained for each of the network connections, the quality score can be determined. In some cases, the quality score can be determined as a combination (such as weighted combination) of the one or more network performance metrics, such as of at least two network performance metrics. In some cases, blended scoring is used to determine the quality score. To perform automatic failover, the quality score of the active network connection (which can be the primary connection, such as pLEO illustrated in FIG. 7) can be compared to the quality score of the next network connection in the order of priority (which can be GEO illustrated in FIG. 7). If the highest quality score associated with the next network connection exceeds the quality score of the active network connection, communication can be automatically switched to that next network connection. In some cases, the highest quality score of the next network connection would need exceed the quality score of the active network connection by at least a threshold margin to ensure that failover is justified and not performed too frequently. For instance, with reference to FIG. 7, suppose that the highest quality score of GEO is only one point higher than the quality score of pLEO. In this case, performing the failover would not be justified as marginal improvement from switching the network connection from pLEO to GEO would not be justified by the cost of any delay associated with such network connection change.

In some cases, automatic failover can compare the quality score of the active network connection with the highest quality score of all other network connections regardless of the order of priority.

FIG. 8 illustrates the communications screen 604 that shows completion of the automatic failover responsive to determining that the quality of the active network connection is unsatisfactory. The failover can be performed in response to determining that active network connection, which is illustrated as being the primary connection 624 (pLEO), is determined to be unsatisfactory, as described herein. Automatic failover can switch communication to the contingent network connection which is illustrated as 626 (GEO), that becomes the active network connection as shown at 611. Operator can be notified of the switch of the network connections, as illustrated by the message 628. The order of the network connections on the screen 604 may not change as a result of failover (the primary connection 624 can remain at the top of the displayed list even though it may not be the active network connection).

In some implementations, failover can automatically switch the active connection back to the primary connection (pLEO) when the connection quality sufficiently recovers. As described herein, this may be performed responsive to the quality score of the primary connection exceeding the quality score of the contingent connection (GEO) by at least the threshold margin.

Advantageously, automatic failover can reduce operator's burden from having to monitor network connection quality and manually switch network connections. Automatic failover can be disabled in some instances, which would cause the operator to perform manual failover.

### Remote Monitoring and Predictive Maintenance

As is described in connection with FIG. 3, data regarding the operation of one or more control and communications systems can be transmitted one or more external computing systems (such as the Lattice system 1810) to facilitate one or more of remote monitoring, predictive maintenance, or control. Such data can include one or more of health data, metrics, logs, alerts, state, or the like. That is, the current state of any control and communications system can be made available remotely and predictive maintenance can be facilitated.

FIG. 21 illustrates a block diagram of an example operational environment 1400 for remote access and predictive maintenance. Multiple control and communications systems 1410 can be connected to networks and/or datalinks 1415 (which can be similar to 1802) which can provide communications among the various components of the operational environment 1400. The control and communications systems 1410 can communicate with one or more external computing devices 1420 such as a Lattice system. Data regarding the operation of one or more control and communications systems can be transmitted to the one or more external computing devices 1420, which can store the data. Data can be transmitted periodically when network connectivity is available, or batches of data can be collected by the control and communications device and transmitted when network connectivity becomes available.

The one or more external computing devices 1420 can store large amounts of data for many control and communications systems over long time periods to facilitate, among others, predictive maintenance. The memory capacity of the one or more external computing devices 1420 can greatly exceed the memory capacity of any individual control and communications system, which can facilitate storage of much greater amounts of data related to the control and communications systems. As a result, data stored by the one or more external computing devices 1420 can be much more complete than data stored by an individual control and communications system. Predictive analytics can be performed on the data to determine whether any control and communications system(s) may be malfunctioning currently or may be malfunctioning in the near future. Should this be the case, remedial action(s) can be taken, such as providing guidance to the operator for remedying the problem, applying software or firmware patches, or sending replacement hardware. For instance, a determination of whether performance of a particular control and communications system (or a plurality of such systems) is regressing over the last 100 days (or another number of days) is made and, if so, remedial actions are taken.

One or more remote computing devices 1430 can communicate with the one or more external computing devices 1420, receive information related to the current state of any of the control and communications systems 1410, and output, among other information, the current state to a remote user.

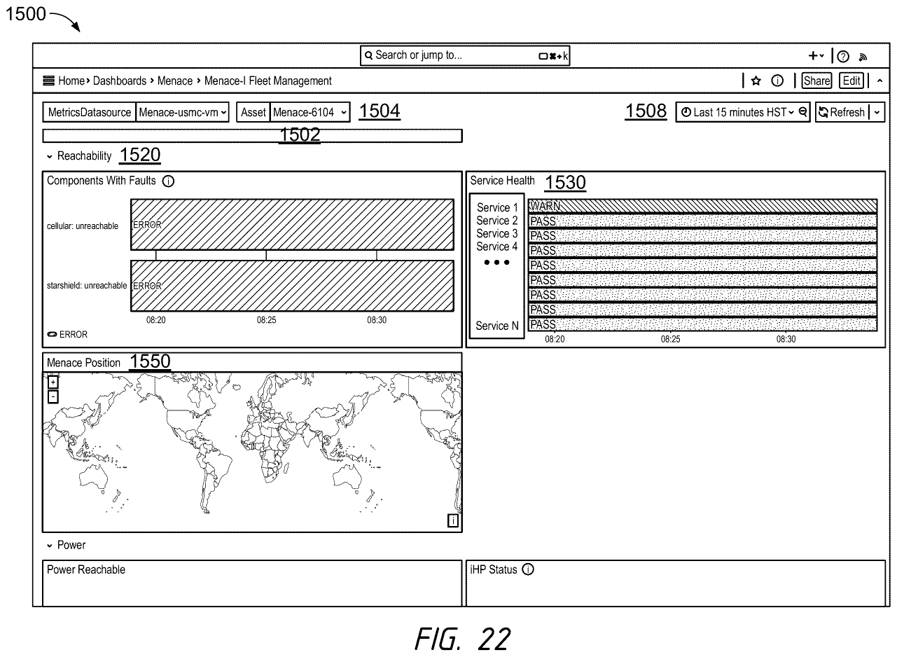

FIG. 22 illustrates a screen 1500 (or dashboard) showing status of a particular control and communications system shown (called “menace-6104” as shown at 1502). The screen 1500 can be output by any of the remote computing devices 1430 in FIG. 21. The particular control and communications system can be selected via a user interface control 1504 (such as a drop down), which can be used to select a different control and communications system for display on screen 1500. For example, any control and communications system that is part of a fleet of control and communications systems is selected. The screen 1500 illustrates the following statistics: connectivity status 1520 (including illustrating network connections that are not operating correctly), health of services 1530 (such as software or firmware services), and position of the control and communications system 1550. Other statistics may be illustrated, such as charge level of a battery, status of power source(s), latency of network connections, etc.

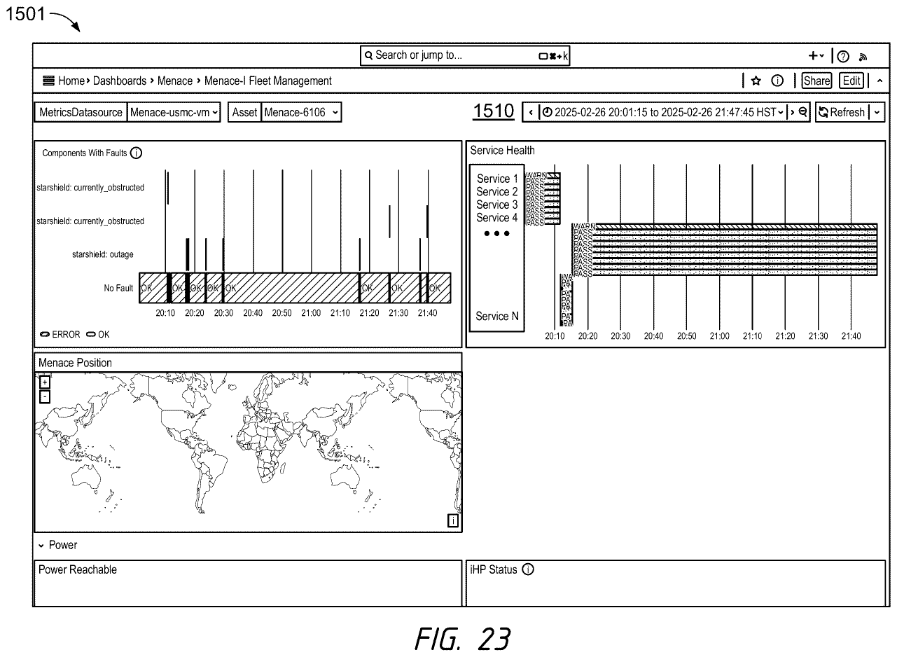

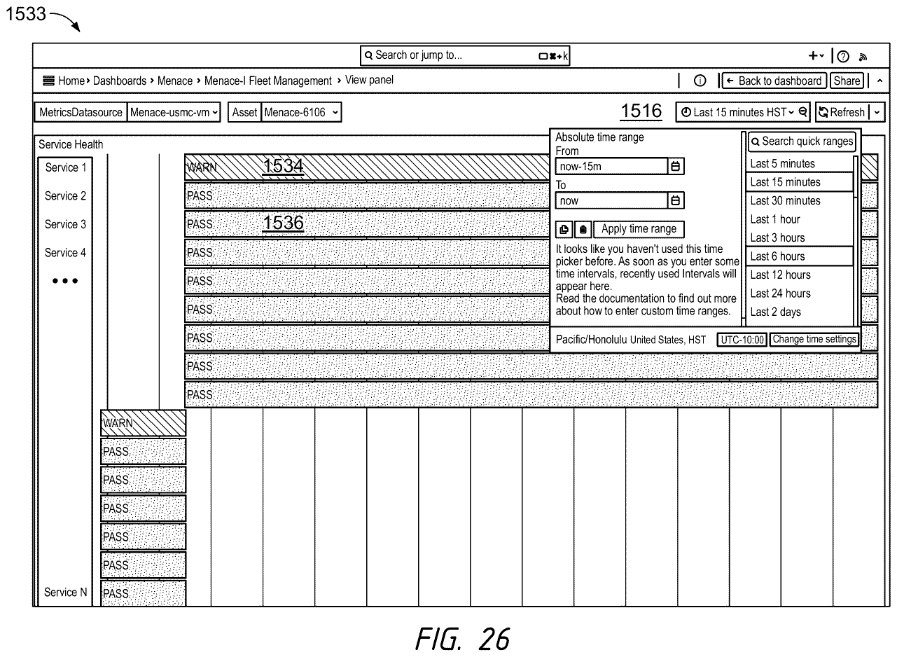

Statistics can be illustrated chronologically over a time period. The time period over which the statistics are presented on the screen 1500 can be selected at 1508. For instance, screen 1500 shows statistics for the last 15 minutes. The time period can be changed to hours, days, months, or custom time period can be selected by a user (see FIG. 26). FIG. 23 illustrates a screen 1501 that presents statistics over a longer time period 1510, which is shown as a custom time period (2025 Feb. 26 from 20:01:05 to 21:47:45). There can be a default time period for initial output of the statistics or in cases when no selection of the time period has been made.

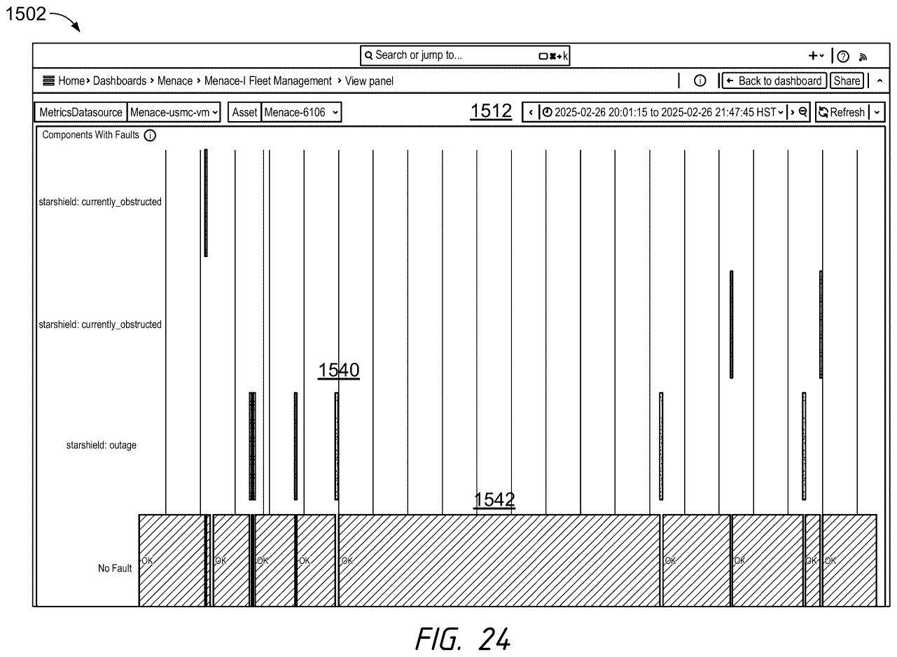

FIG. 24 illustrates a screen 1502 that presents a detailed view of connectivity status over a time period. The screen 1502 can be accessed from the screen 1500 (such as by clicking in the region 1520). The time period illustrated is selected as the last 15 minutes as shown at 1512. Network connections 1542 that are operating correctly can be shown in different color (such as green) than network connections 1540 that are faulty and not operating correctly (such as red). Output of any faults can correspond to that described herein in connection with the MMI.

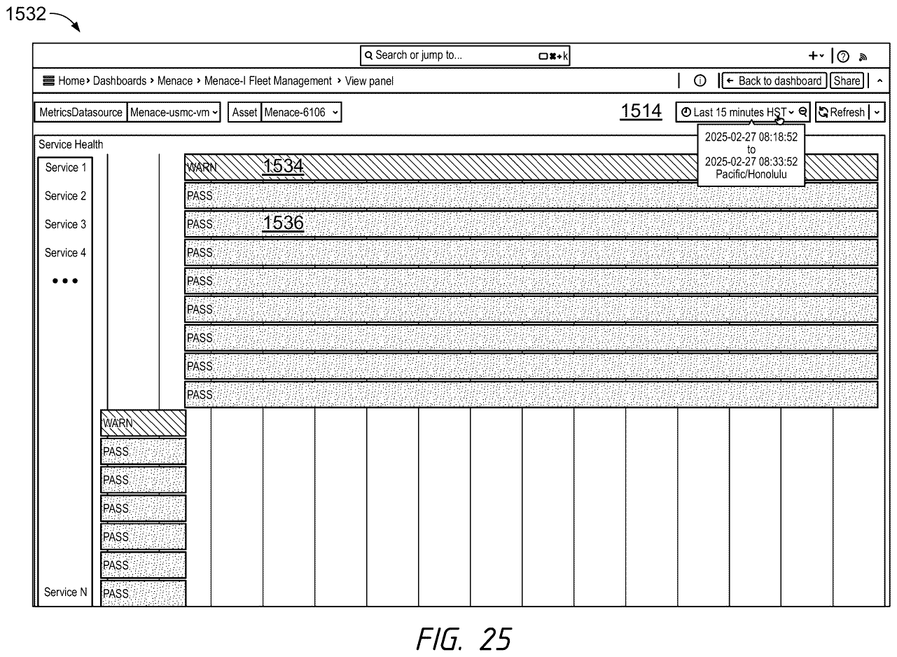

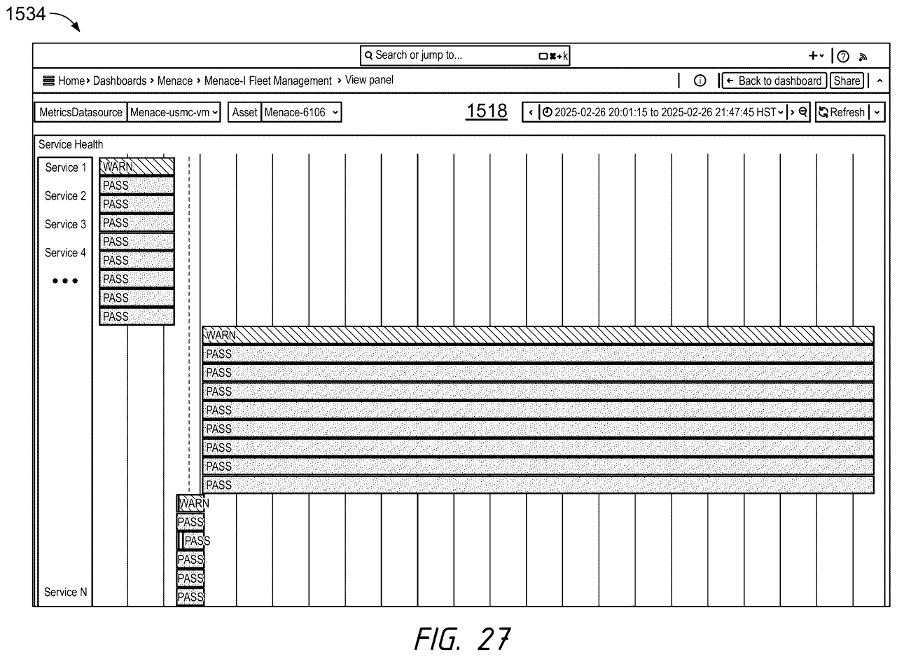

FIG. 25 illustrates a screen 1532 that presents a detailed view of the health of services over a time period. The screen 1532 can be accessed from the screen 1500 (such as by clicking in the region 1530). The time period illustrated is selected as the last 15 minutes as shown at 1514. Service components that are operating correctly 1534 can be shown in different color (such as green) than services that network connections 1536 that have a warning (such as yellow) and service components that are not operating correctly (such as red). FIG. 26 illustrates a screen 1533 that presents a detailed view of health of services over a period of time that can be selected with a filter 1516. As is shown, various periods of time spanning minutes, hours, days, or custom ranges of time can be selected. FIG. 27 illustrates a screen 1534 that presents a detailed view of health of services over a longer period of time than that illustrated in FIG. 25. As is shown at 1518, the period of time is a custom period (2025 Feb. 26 from 20:01:15 to 21:47:45). The output of any faults can correspond to that described herein in connection with the MMI.

Determinations of whether a particular network connection or service component is operating correctly, not operating correctly, or may have an issue (which may be indicated by a warning) can be made by comparing the metrics received from the one or more control and communications systems to one or more thresholds. Alerts associated with the determination of incorrect operation or an issue can be generated and output on the one or more remote computing devices 1430 or transmitted to another remote computing device.

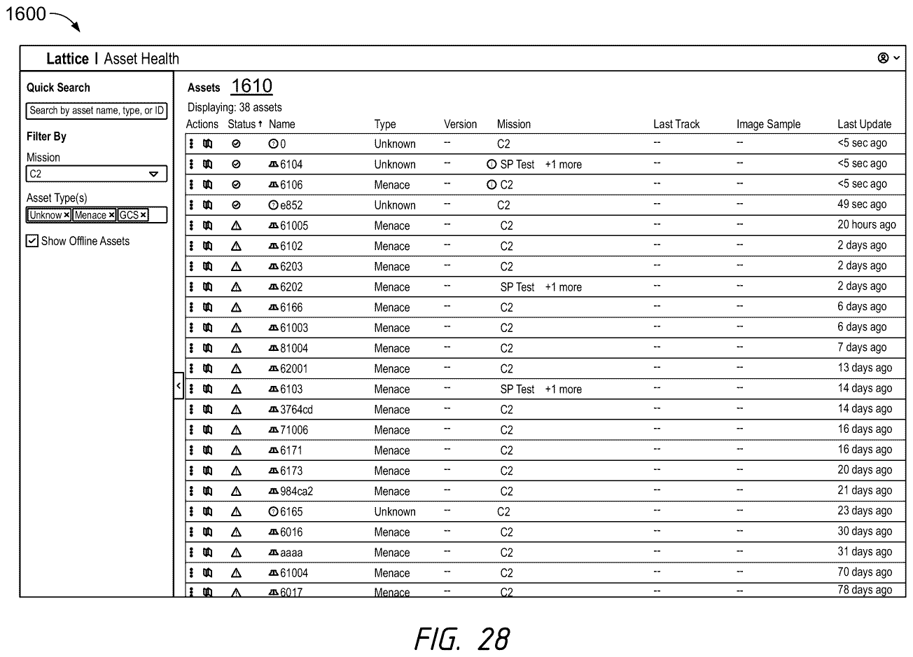

FIG. 28 illustrates a software or firmware update screen 1600. Different control and communications systems that are available are listed in the list 1610. The type of software or firmware update can be selected at 1612. For instance, MMI software (running on the computing system 306), Menace software (running on the computing system 304), or Lattice software (running on the computing system 302) can be updated. Once the software or firmware update bundle has been downloaded by a particular control and communications system, it can be applied at an appropriate time (such as when the system is not being used by the operator). The particular control and communications system can upload the update bundle to a central repository that can be accessed and applied by other control and communications systems that may not be connected to one or more external computing devices 1420 (such as not visible in the list 1610).

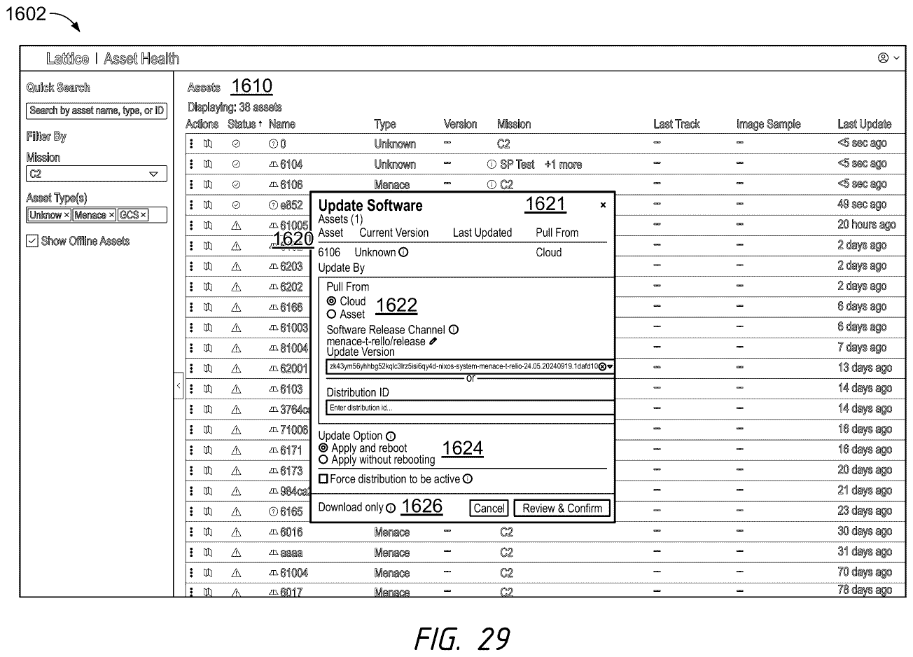

FIG. 29 illustrates another software or firmware update screen 1602 that shows updating a particular control and communications system 1620 (“6106”), which has been selected in the list 1610. An update software user interface control 1621 facilitates selection of the source of the update 1622, which can be downloaded from the one or more external computing devices 1420 or from the central repository, as described herein. The user interface control 1621 provides a selection 1624 of whether the update should be applied with or without rebooting a computing system of the control and communications system. The user interface control 1621 provides a selection 1626 to only download the update but not apply it. This would permit the update to be available on the control and communications system for being applied at a later time.

The update screens 1600 and 1602 can be accessed by one or more remote computing devices 1430 or directly by a control and communications systems.

Pushing the updates described in connection with FIGS. 28 and 29 can be advantageous to pulling the updates from a particular control and communications system. Remote software or firmware update functionality can provide flexibility and efficiency when compared to manually updating each control and communications system.

While not illustrated in FIGS. 22 to 29, information related to a fleet of control and communications systems can be similarly provided and their software or firmware can be similarly updated.

The user interfaces disclosed in the section can resemble web-based graphical user interfaces (such as web pages).

### Body-Worn Control and Communications System

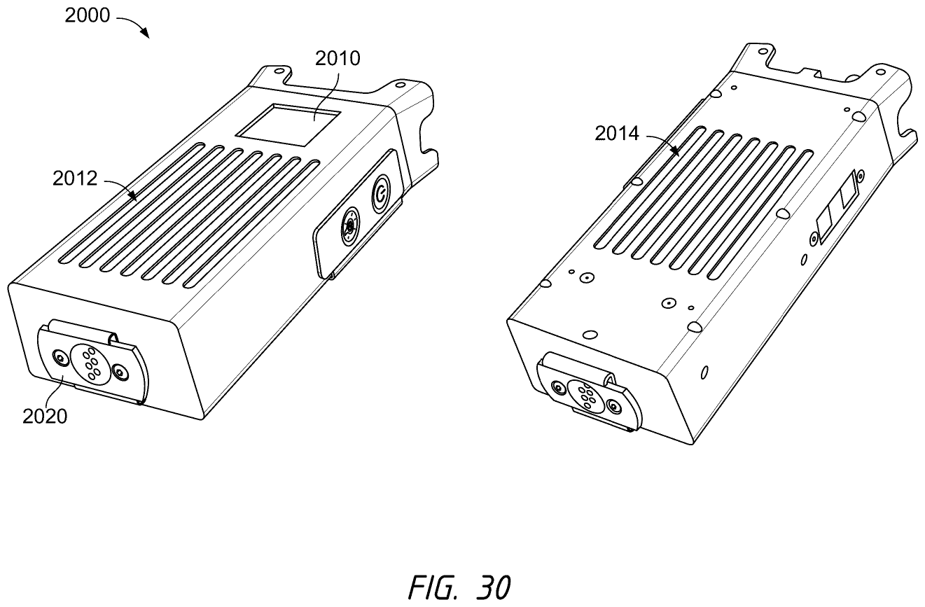

FIGS. 30, 31, and 32 illustrate several views of a body-worn control and communications system 2000. As is used herein, body-worn encompasses being at least partially supported by a human body, such as being attached to an article of clothing, carried in a pocket or compartment, or the like. Advantageously, the control and communications system 2000 can enhance situational awareness and operational efficiency to support a wide range of mission scenarios. The control and communications system 2000 can deliver data and control and communications capabilities directly to frontline personnel. For example, real-time tactical data for informed decision-making is delivered. Precise tracking of unit positions can be enabled to improve coordination and operational efficiency. The control and communications system 2000 can act as a hub for processing and outputting drone reconnaissance data and enabling collection of data from sensors and operators and provide situational awareness to the individual operator. The control and communications system 2000 can be complementary with a suitable end-user device, such as a heads-up display, a phone, or a tablet.

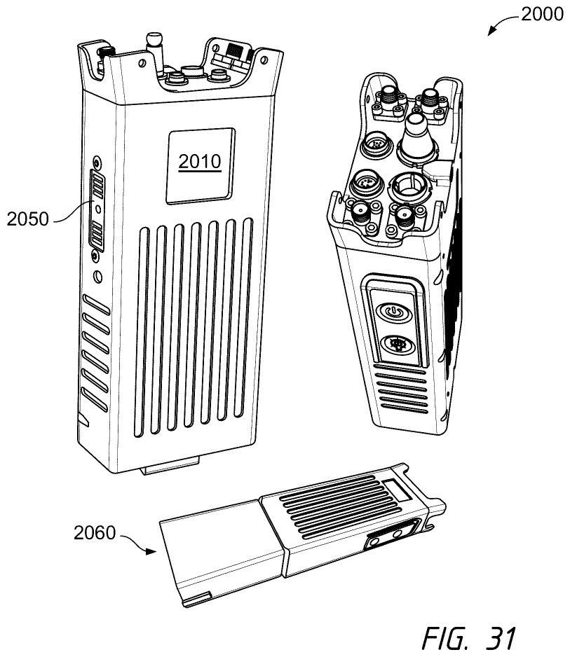

Advantageously, the form factor of the control and communications system 2000 (or size and dimensions of the housing) can be the same or similar to the form factor of a tactical radio (such as an MBITR radio). Advantageously such form factors are ubiquitous and familiar to end users. The control and communications system 2000 can include a connector 2020 for attaching an external battery, such as a standard MBITR compatible battery. The connector 2020 can be a twist lock connector. In some implementations, a component (such as a radio) can be connected to the connector 2020 in addition to or instead of an MBITR battery. With reference to FIG. 31, the control and communications system 2000 with an attached external battery is illustrated at 2060.

The control and communications system 2000 can include a display 2010 that can provide at least some features of the MMI described herein. For example, the display outputs status of one or more connections (such as GPS, cellular signal level, WiFi signal level, etc.), provide notifications (such as Lattice notifications).

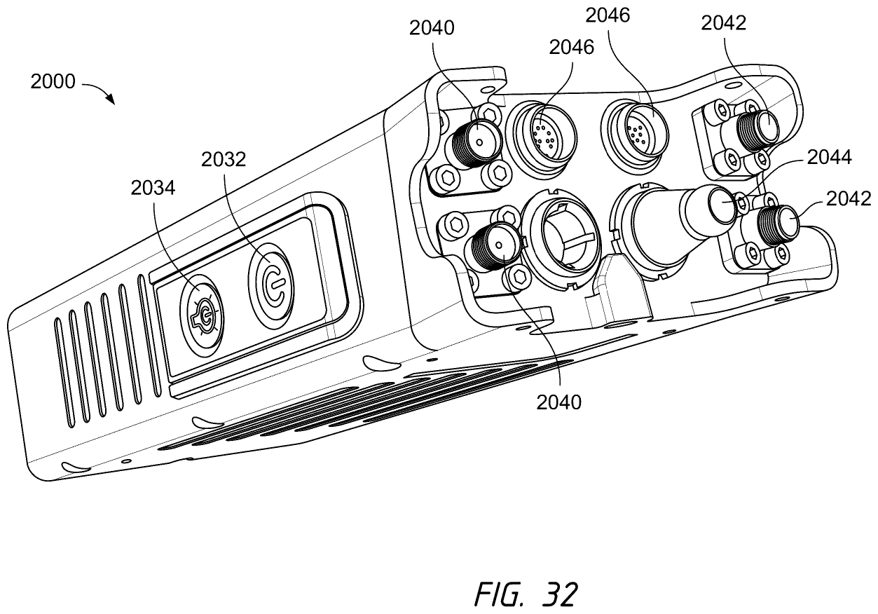

With reference to FIG. 32, the control and communications system 2000 can include a power button 2032 and a display control button 2034 that can turn off the display to cease light emission. In some cases, the button 2034 can be a multifunction button that can be configured to, for instance, control EMCOM.

At the top portion of its housing, the control and communications system 2000 can include a variety of connectors: SMA connectors 2040 and 2042 for connecting antennas and communication modules (such as cellular or WiFi), male NetWarrior connector 2044 for connecting a conformal battery, ODU connectors 2046 for USB and Ethernet, and a female NetWarrior connector 2048 for USB. Each of the connectors can be a standard connector to promote interoperability with existing cables and modules. In some implementations, one or more antennas can be integrated into a housing of the control and communications system 2000.

With reference to FIG. 31, the control and communications system 2000 can have a connector 2050 positioned on the side of its housing. The connector 2050 can be a USB connector.

The control and communications system 2000 can receive power from one or more power sources: a conformal battery (which is a standard, lightweight and wearable battery) or an MBITR battery (which is a standard battery). The conformal battery can be a primary source of power and MBITR battery can be a secondary source of power. In some cases, both batteries can be connected to provide power to the control and communications system 2000.

With reference to FIG. 30 that illustrates top and bottom views of the control and communications system 2000, the housing includes heat sinks 2012 and 2014 for colling the internal components of the control and communications system. Components that produce more heat in use can be positioned to be in contact with one of the heatsinks to facilitate passive colling. The housing can be made of durable, lightweight, and thermally conductive material, such as aluminum alloy.

Advantageously, the control and communications system 2000 can be modular and interoperable with existing components, such as cables, power sources, output devices (such as heads-up displays), or communication devices and network connections. The control and communications system 2000 can be extensible and may support a wide variety of peripheral devices (or accessories), such as heads-up displays, external displays, human interaction devices (HID), communication devices, or the like, via connection to the one or more connectors.

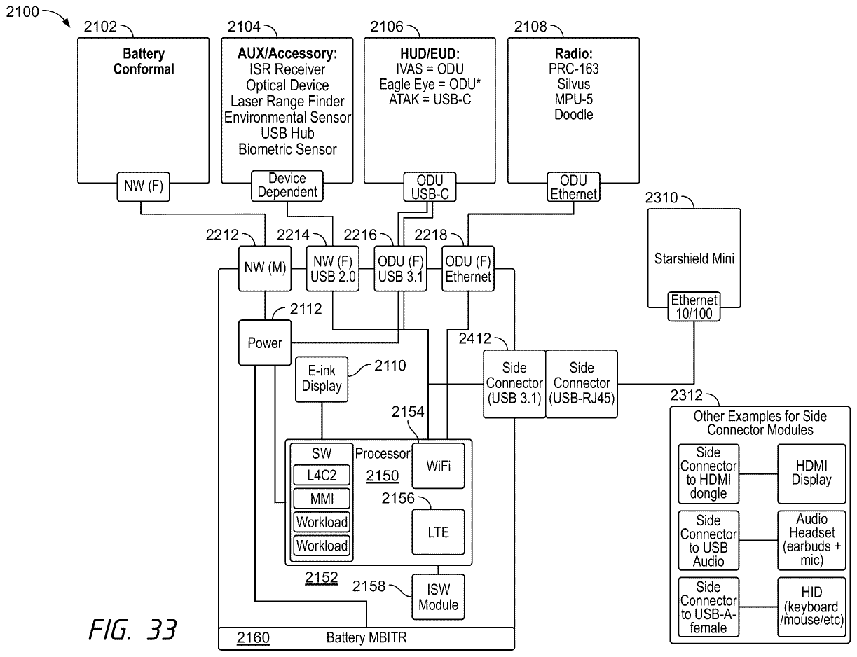

FIG. 33 illustrates a system diagram 2100 of the control and communications system 2000. The control and communications system can include a voltage regulator 2112 configured to regulate power received from one or more power sources or provide power to one or more connectors (such as connectors 2212 and 2216 as shown) for powering one or more peripheral devices, such as a conformal battery 2102, MBITR battery 2160, or one or more connectors (such as USB connectors 2216). Processing circuitry 2150 can include at least one processor, memory (not shown), and one or more communication modules, such as a WiFi communication module 2154 and a cellular communication module 2156. The processing circuitry 2150 can be connected by a data bus to an intra-soldier wireless (ISW) communication module 2158 to enable ISW communications. The processing circuitry can be connected by a data bus to a display 2110, which can be a low power electronic paper display (such as electronic ink display).

The at least one processor can be efficient and configured to run multiple software applications 2152, including Lattice (illustrated as “L4C2”), MMI, and Auto PACE among others. The control and communications system 2000 can be a fully functional edge computer. In some cases, the display 2110 may not be configured to output one or more aspects of the MMI user interface (for instance, the display does not render graphics or color). In such cases, the display 2110 may output a scaled-down MMI user interface. A full-featured MMI user interface may be output one or more peripheral devices connected to the control and communications system 2000, such as an external display (such as HDMI display), heads-up display, or the like.

The control and communications system 2000 can support one of more of the following communication protocols: GNSS/GPS, muti-band WiFi, and Bluetooth. GNSS/GPS connectivity can be used for positioning and location. WiFi connectivity can be used for communicating with other devices or systems. Bluetooth connectivity can be used for communicating with other proximal devices, such as one or more sensors.

Additional communication modules can be connected via one or more connectors to support additional or alternative communication protocols, such as Ethernet (for LAN/WLAN) or satellite (for instance, Strarlink or Starshield 2310).

The control and communications system 2000 can include a male NetWarrior connector 2212 for connecting a conformal battery 2102, a female NetWarrior connector 2214 for connecting an accessory 2104 (such as one or more biometric sensors, optical devices, laser devices, or reconnaissance devices), an ODU connector 2216 for connecting a peripheral device 2106 via USB, such as a headset with a heads-up display (for example, Integrated Visual Augmentation System (IVAS), Soldier Borne Mission Command (SBMC) system, or another body-worn device that integrates augmented reality (AR), virtual reality (VR), or mixed reality (MR) or an Eagle Eye helmet that integrates AR, VR, or MR) or an ATAK device for receiving real-time situational awareness, another ODU connector 2218 for connecting another peripheral device 2108 (such as a radio) via Ethernet to support, for instance, one or more of WiFi or ad hoc networking (such as mobile ad hoc network (MANET)), and a connector 2412 for connecting yet another peripheral device 2310/2312 (such as satellite connection module, external display, audio headset, HID, or sensor) via USB. Examples of devices that provide MANET communications include PRC-163 radio, Silvus radio, MPU5 radio, or Doodle radio. MANET communications can be formed over one or more of WiFi, cellular, or RF.

Connectors 2212, 2214, 2216, and 2218 can be positioned at the top of the housing. Connector 2412 can be positioned on the side of the housing.

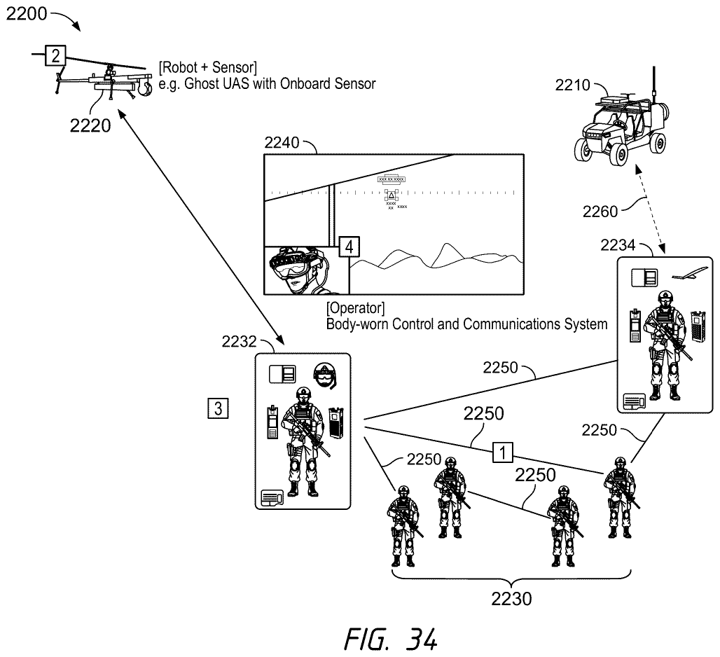

FIG. 34 illustrates an example operating environment 2200 for such control and communications systems, such as the control and communications system 2000. A control and communications system 2210 can deploy an asset 2220 that has one or more sensors, such as Anduril's Ghost UAV that scans an area of interest. A group of personnel 2230 may include, among others, an operator 2232 that carries a control and communications system (such as another control and communications system that is body-worn, such as IVAS, SBMC, and/or the like) in communication with a heads-up display (HUD) and another operator 2234 that carries another body-worn control and communications system. Other members of the group 2230 may or may not carry a control and communications system, but, in any case, may carry a communication device. Operator 2232 can communicate via its control and communications system with the asset 2220 and receive data from the asset 2220. At least some of the received data can be output by the heads-up display, as illustrated at 2240. Communication between operator's 2232 control and communications system and the asset 2220 can be performed over MANET network (which can be a decentralized temporary network). Data received from the asset 2220 can be shared with other members of the group 2230 via LAN/WLAN network, which can be a mesh network (such as a Lattice mesh network). Lattice can function as a distributed software system that accepts sensor data (for instance, from the asset 2220) and autonomously integrates such data to build a unified view of the entire area of interest, while bringing attention to the most salient features of interest (such as targets). As is shown, LAN/WLAN network can provide a “horizontal” communication pathways 2250 with local communication devices.

Operator's 2234 control and communications system can be connected via WAN to one or more computing devices that are external to the LAN/WLAN. WAN connection can be made through, for example, satellite network (such as Starlink or Starshield) or cellular network. As is shown, WAN network can provide a “vertical” communication pathway 2260 with one or more external computing devices. Data received from the asset 2220 can be communicated externally through WAN connection. In some instances, data (such as instructions or commands) can be received from the external environment through WAN connection and shared with the other members the group 2230 via LAN/WLAN.

The vertical communication pathway 2260 can be shared with the other members of the group 2230 via LAN/WLAN. That is, other members of the group 2230 may see the availability of connection to one or more external computing devices (for instance, via MMI) and communicate with such one or more external computing devices. The communication can be accomplished first via the horizontal communication pathway 2250 to the operator's 2234 control and communications system and then via the vertical communication pathway 2260.

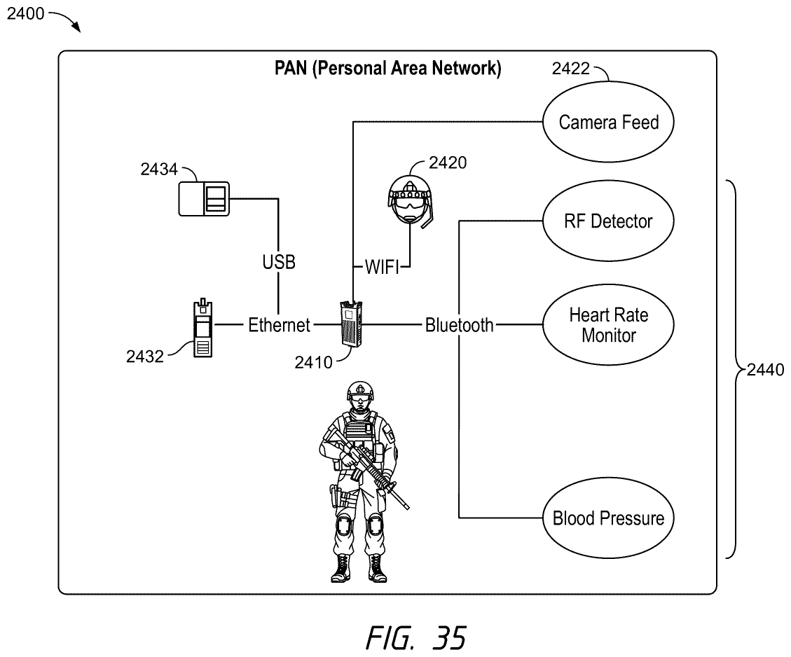

FIG. 35 illustrates a schematic diagram 2400 of a personal area network (PAN) formed using a control and communications system 2410 carried by an operator, such as the control and communications system 2000. A heads-up display 2420 (such as IVAS, SBMC system, and/or the like) can be connected to the control and communications system 2410, such as via WiFi or USB. The heads-up display 2420 can have a camera and the control and communications system 2410 can receive a video feed 2422 from the camera. The control and communications system 2410 can be connected to a radio 2432, such as via Ethernet, and to an external display 2434, such as via USB. The control and communications system 2410 can be connected to one or more sensors 2440 as shown, such as via Bluetooth. The one or more sensors 2440 can include sensors that monitor health of the operator, such as the heart rate, blood pressure, or another physiological parameter, as well as sensors that monitor other parameters, such as environmental parameters or operational state of equipment.

The control and communications system 2410 can form PAN for communicating data with illustrated peripheral devices. The control and communications system 2410 can enable communication of data between any of the peripheral devices and one or more other control and communications systems or their peripheral devices (via an available horizontal communication pathway) or one or more external computing devices (via an available vertical communication pathway). In some cases, the control and communications system 2410 can be a Lattice network node that exposes Lattice capabilities to any of the peripheral devices. For instance, Lattice capabilities are exposed via an application programming interface (API) or a software development kit (SDK). Advantageously, the peripheral devices would not need to reimplement the logic for communicating with other devices. Data obtained by any of the connected peripheral devices can be shared with any other operator present on a LAN/WLAN or any external computing device present on a WAN.

As described herein (such as in the section titled “Connection Failover” and below), horizontal and vertical communication pathways can be automatically monitored, and failover can be performed when necessary.

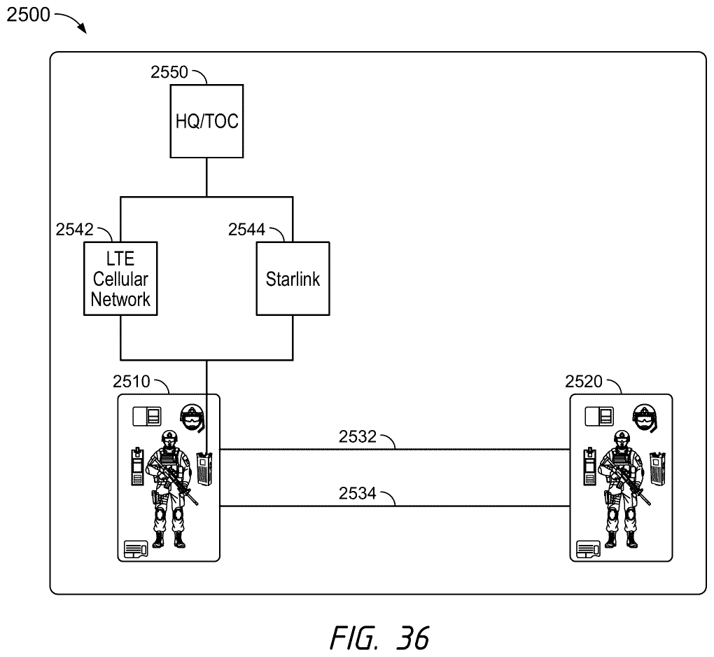

FIG. 36 illustrates a schematic diagram 2500 of communications involving two operators 2510 and 2520 carrying control and communications systems, such as the control and communications system 2000. The control and communications systems carried by the operators 2510 and 2520 can be connected to similar peripheral devices as described in connection with FIG. 35. Operators 2510 and 2520 can communicate with each other using two horizontal communication pathways 2532 and 2534 (LAN/WLAN communication pathways), which can be WiFi and MANET. Operator's 2510 control and communications system is connected to one or more external computing systems 2550 over two vertical communication pathways 2542 and 2544 (WAN communication pathways), which can be cellular (such as LTE) and satellite (such as Starlink or Starshield). Operator 2520 can take advantage of the vertical communication pathways provided by the control and communications system of the operator 2510 to communicate with the one or more external computing systems 2550. As described herein, the availability of vertical communication pathway can be indicated on a user interface, such as MMI, provided by the control and communications system of the operator 2520. For instance, user interfaces similar to those illustrated in FIGS. 7 and 8 are provided on a display of the control and communications system or connected peripheral device (such as IVAS, SBMC system, and/or the like). Examples of IVAS, SBMC systems, and/or similar systems are described in U.S. Provisional Patent Application No. 63/867,413, filed on Aug. 20, 2025, the entire disclosure of which is hereby made part of this specification as if set forth fully herein and incorporated by reference for all purposes, for all that it contains.

Control and communications systems of the operators 2510 and 2520 can monitor the horizontal communication pathways 2532 and 2534 and perform automatic failover, as described herein. Control and communications systems of the operators 2510 and 2520 can monitor the vertical communication pathways 2542 and 2544 and perform automatic failover. In some cases, the control and communications system of the operator 2520 can perform automatic failover for an entire communication pathway to the one or more external computing systems 2550, which can involve performing a failover on the horizontal communication pathways 2532 and 2534 and the vertical communication pathways 2542 and 2544. This can involve determining quality scores of the horizontal and vertical communication pathways and performing failover, as described herein.

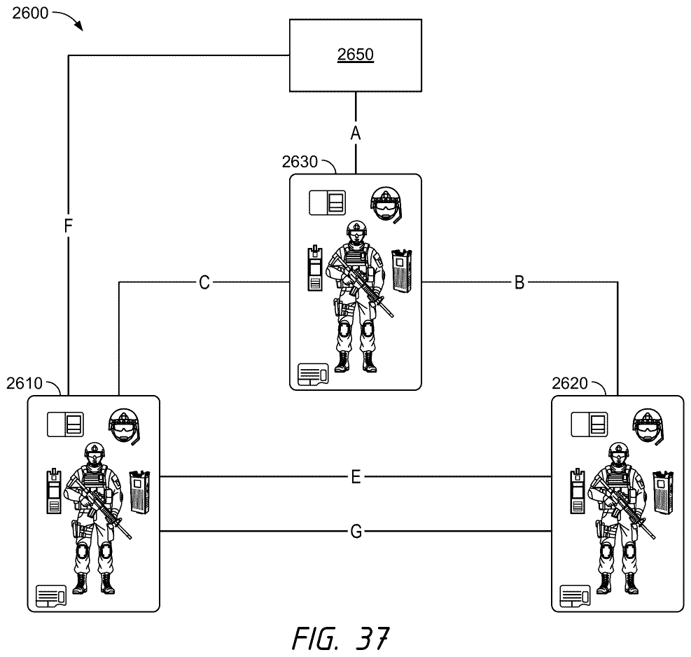

FIG. 37 illustrates a schematic diagram 2600 of communications involving three operators 2610, 2620, and 2630 carrying control and communications systems, such as the control and communications system 2000. Operators 2610 and 2620 can communicate with each other over horizontal communication pathways E and G, which can be WiFi and MANET. Operators 2620 and 2630 can communicate with each other over a horizontal communication pathway B, which can be MANET. Operators 2610 and 2630 can communicate with each other over a horizontal communication pathway C, which can be MANET.

Operators 2610 and 2630 can communicate with one or more external computing systems 2650 over horizontal communication pathways F and A, respectively. For example, communication pathway F is a cellular connection, and communication pathway A can be a satellite connection. Operator 2620 can be presented with options of using horizontal communication pathways B, E, and G as possible routes as well as vertical communication pathways A and F for communicating with the one or more external computing systems 2650.

Control and communications systems of the operators 2610, 2620, and 2630 can monitor the horizontal communication pathways C, B, E, and G and vertical communication pathways A and F and perform automatic failover, as described herein. This can involve determining quality scores of the horizontal and vertical communication pathways and performing failover. For example, operator 2620 selects the order of priority of the horizontal or vertical communication pathways, as described herein. Operator 2620 can select the horizontal communication pathway B and vertical communication pathway A as a primary connection (e.g., because pathway A may be faster than pathway F or because pathway B may be faster than pathways E and G), the horizontal communication pathway E and vertical communication pathway F as a contingent connection, and the horizontal communication pathway G and the vertical communication pathway F as an emergency connection (e.g., because pathway G may be slower than pathway E). In response to determining that it would be more efficient for the operator 2620 to communicate with the one or more external computing systems 2650 using the contingent connection, communication can be automatically switched to the contingent connection (E and F). In response to a subsequent determination that it would be more efficient for the operator 2620 to communicate with the one or more external computing systems 2650 using the emergency connection, communication can be automatically switched to the emergency connection (G and F).

To facilitate determination or dissemination of quality scores for performing failover, control and communications systems of the operators 2610 and 2630 can provide one or more network performance metrics obtained for the vertical communication pathways F and A or the quality scores determined for these vertical communication pathways to the control and communication system of the operator 2620, which is not directly connected via a vertical communication pathway. Such one or more network performance metrics can be provided over the horizontal communication pathways. As described herein, connection monitoring and dissemination of the quality scores can be performed periodically to not unduly interfere with normal operation.

To facilitate efficient determination or dissemination of quality scores for performing failover without unduly interfering with normal operation, associated network traffic can be reduced. One or more network performance metrics or quality scores can be combined. For instance, network performance metrics or quality scores for communication pathways A and B are combined with network performance metrics or quality scores for communication pathway C (which may be known to the operator 2630) and communicated to the operator 2620 in order to reduce the overhead network traffic. Advantageously, this can enable utilizing parts of the network and not the entire network.

In some cases, it may be more efficient for the operator 2610 to communicate with the one or more external computing systems 2650 using the vertical communication pathway A of operator 2630 (and the horizontal communication pathway C), rather than operator's 2610 own vertical communication pathway F. In such cases, automatic failover can switch communication from the direct vertical communication pathway A (which can be selected as a primary connection) to the indirect communication pathway C and A (which can be selected as a secondary connection).

As is described herein, one or more sensors that can monitor health of an operator can be connected to a control and communications system carried by the operator, such as the control and communications system 2000. Data from such one or more sensors can be communicated by the control and communications system to one or more other control and communications systems or external computing systems so that the health of the operator (such as vital signs) can be monitored externally. For instance, the status of the operator is monitored via Lattice. Advantageously, this can assist with planning and execution. As an example, suppose that an accident, natural disaster, or another life threating event has occurred and limited search and rescue resources need to be prioritized. Monitoring the health status of operators can provide information regarding location of the operators and identify operators who are alive, which can facilitate triaging.

More generally, any electronic device can become a Lattice node that can provide information and whose status can be monitored externally through attaching or connecting the device to a control and communications system, such as the control and communications system 2000 that is extensible and interoperable as described herein. For example, a vehicle or robot becomes a Lattice node that may provide information or may be controlled remotely.

### Terminology and Additional Implementation Details and Embodiments

Any of the communication channels or pathways described herein may be secured or encrypted. While certain user interface components have been described and/or illustrated (such as input elements, output elements, navigational elements, informational elements, or container elements), other alternative of additional user interface components can be used.

Various implementations of the present disclosure comprise one or more systems, methods, computer-readable storage mediums, and/or computer program products at any possible technical detail level of integration. In various implementations, a computer program product (or products) includes one or more computer-readable storage mediums. The computer-readable storage medium(s), according to various implementations, comprise, are configured to store, and/or store computer-readable program instructions that are executable to cause a processor to carry out aspects of the present disclosure.

For example, various of the functionality described herein, in some implementations, is performed as software instructions that are executed by, and/or in response to software instructions being executed by, one or more hardware processors and/or any other suitable computing devices. The software instructions and/or other executable code may be read from one or more computer-readable storage mediums.

The computer-readable storage medium(s) is a tangible device that retains and stores data and/or instructions for use by an instruction execution device, e.g., a processor. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein, according to some implementations, are downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. In some implementations, a network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression or decryption prior to execution) that may then be stored on a computer-readable storage medium. Such computer-readable program instructions may be stored, partially or fully, on a memory device (e.g., a computer-readable storage medium) of the executing computing device, for execution by the computing device. According to various implementations, computer-readable program instructions execute entirely on a user's computer (e.g., the executing computing device), partly on the user's computer as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) executes the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, are implementable by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowchart and block diagrams in the Figures illustrate the architecture, functionality, and operation of possible implementations of systems, methods, and computer-program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks occur out of the order noted in the Figures. For example, two blocks shown in succession may be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, are implementable by special purpose hardware-based systems that perform the specified functions or acts or carry out combinations of special purpose hardware and computer instructions. For example, any of the processes, methods, algorithms, elements, blocks, applications, or other functionality (or portions of functionality) described herein may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the implementations of the present disclosure may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows 11, Windows Server, etc.), Windows CE, Unix, Linux, SunOS, Solaris, Blackberry OS, VxWorks, or other suitable operating systems. In other embodiments, the computing devices are controlled by a proprietary operating system, or a combination of proprietary and/or other operation systems. Conventional operating systems control and schedule computer processes for execution, perform memory management, provide file system, networking, I/O services, and provide a user interface functionality, such as a graphical user interface (“GUI”), among other things.

In various implementations certain functionality is accessible by a user through a web-based viewer (such as a web browser), or other suitable software program. In some implementations, the user interface (and/or user interface data usable for rending a user interface) is generated by a server computing system and transmitted to a web browser of the user (e.g., running on the user's computing system). Alternatively, data (e.g., user interface data) necessary for generating the user interface is provided by the server computing system to the browser, where the user interface is generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure include mobile computing devices, and user interfaces may be accessible through such mobile computing devices (for example, smartphones, tablets, virtual and/or augmented reality glasses, and/or the like).

While certain implementations of the inventions have been described, these implementations have been presented by way of example only, and are not intended to limit the scope of the disclosure. Indeed, the novel methods and systems described herein are implementable in a variety of other forms. Furthermore, various omissions, substitutions and changes in the systems and methods described herein are implementable without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, implementation, or example are to be understood to be applicable to any other aspect, implementation or example described in this section or elsewhere in this specification unless incompatible therewith. All of the features disclosed in this specification (including any accompanying claims, abstract and drawings), and/or all of the steps or blocks of any method or process so disclosed, are combined in any combination, except combinations where at least some of such features and/or steps are mutually exclusive. The protection is not restricted to the details of any foregoing implementations. The protection extends to any novel one, or any novel combination, of the features disclosed in this specification (including any accompanying claims, abstract and drawings), or to any novel one, or any novel combination, of the steps or blocks of any method or process so disclosed.

Furthermore, certain features that are described in this disclosure in the context of separate implementations are also implementable in combination in a single implementation. Conversely, various features that are described in the context of a single implementation are also implementable in multiple implementations separately or in any suitable subcombination. Moreover, although features are described above as acting in certain combinations, one or more features from a claimed combination are, in some cases, excised from the combination, and the combination is claimable as a subcombination or variation of a subcombination.

Moreover, while operations are depicted in the drawings or described in the specification in a particular order, such operations need not be performed in the particular order shown or in sequential order, or that all operations be performed, to achieve desirable results. Other operations that are not depicted or described are incorporated in the example methods and processes. For example, one or more additional operations are performable before, after, simultaneously, or between any of the described operations. Further, in various implementations, the operations are rearranged or reordered in other implementations. Those skilled in the art will appreciate that in some implementations, the actual steps taken in the processes illustrated and/or disclosed differ from those shown in the figures. Depending on the implementation, certain of the steps described above are removed, and/or others are added. Furthermore, the features and attributes of the specific implementations disclosed above are, in various implementations, combined in different ways to form additional implementations, all of which fall within the scope of the present disclosure. Also, the separation of various system components in the implementations described above should not be understood as requiring such separation in all implementations, and it should be understood that the described components and systems are, in some implementations, integrated together in a single product or packaged into multiple products.

For purposes of this disclosure, certain aspects, advantages, and novel features are described herein. Not necessarily all such advantages are achieved in accordance with any particular implementation. Thus, for example, those skilled in the art will recognize that the disclosure, in various implementations, is embodied or carried out in a manner that achieves one advantage or a group of advantages as taught herein without necessarily achieving other advantages as are taught or suggested herein.

Conditional language, such as “can,” “could,” “might,” or “may,” unless specifically stated otherwise, or otherwise understood within the context as used, is intended to convey that certain implementations include, while other implementations do not include, certain features, elements, and/or steps. Thus, such conditional language is not intended to imply that features, elements, and/or steps are in any way required for one or more implementations or that one or more implementations necessarily include logic for deciding, with or without user input or prompting, whether these features, elements, and/or steps are included or are to be performed in any particular implementation.

Conjunctive language such as the phrase “at least one of X, Y, and Z,” or “at least one of X, Y, or Z,” unless specifically stated otherwise, is to be understood with the context as used in general to convey that an item, term, and/or the like is either X, Y, or Z, or a combination thereof. For example, the term “or” is used in its inclusive sense (and not in its exclusive sense) so that when used, for example, to provide a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and possibly includes such components as memory, input/output devices, and/or network interfaces, among others.

Language of degree used herein, such as the terms “approximately,” “about,” “generally,” and “substantially,” represent a value, amount, or characteristic close to the stated value, amount, or characteristic that still performs a desired function or achieves a desired result. For example, the terms “approximately”, “about”, “generally,” and “substantially,” according to various implementations, refer to an amount that is within less than 10% of, within less than 5% of, within less than 1% of, within less than 0.1% of, and within less than 0.01% of the stated amount. As another example, in certain implementations, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred implementations in this section or elsewhere in this specification, and are defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of implementations are made and still fall within the scope of the invention. Accordingly, it should be understood that various features and aspects of the disclosed implementations are combinable with or substitutable for one another in order to form varying modes of the discussed devices.

### Example Clauses

Examples of the implementations of the present disclosure are described in view of the following example clauses. The features recited in the below example implementations are combinable with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, are combinable with any one or more other example clauses, or features of the example clauses or other features of the present disclosure.

Clause 1. A computer-implemented method for operating a control and communications system, the computer-implemented method including, by one or more processors executing program instructions: at a first time: setting a first communication link of a plurality of communication links as an active communication link for communicating data, the first communication link being a highest priority communication link as compared to any other communication link of the plurality of communication links; and communicating data over the first communication link; and at a second time: determining a quality score of each communication link of the plurality of communication links based on at least one quality metric of each communication link; determining that a quality score of a second communication link of the plurality of communication links exceeds a quality score of the first communication link, the second communication link being a lower priority communication link than the first communication link; and in response to determining that the quality score of the second communication link exceeds the quality score of the first communication link, setting the second communication link as the active communication link for communicating data and communicating data over the second communication link, wherein switching the active communication link from the first communication link to the second communication link is performed automatically.

Clause 2. The computer-implemented method of Clause 1, further including at the second time: determining that the quality score of the second communication link exceeds by at least a margin the quality score of the first communication link; and in response to determining that the quality score of the second communication link exceeds by at least the margin the quality score of the first communication link, setting the second communication link as the active communication link and communicating data over the second communication link.

Clause 3. The computer-implemented method of Clause 1, further including at the second time: determining that the quality score of the second communication link does not exceed by at least a margin the quality score of the first communication link; and in response to determining that the quality score of the second communication link does not exceed by at least the margin the quality score of the first communication link, continuing to communicate data over the first communication link.

Clause 4. The computer-implemented method of any one of Clauses 1-3, further including, at a third time subsequent to the second time: determining at least one subsequent quality score of each communication link of a plurality of communication links; determining that at least one subsequent quality score of the first communication link exceeds at least one subsequent quality score of the second communication link; and in response to determining that the at least one subsequent quality score of the first communication link exceeds the at least one subsequent quality score of the second communication link, setting the first communication link as the active communication link for communicating data and communicating data over the first communication link.

Clause 5. The computer-implemented method of any one of Clauses 1-4, further including, at a third time subsequent to the second time: determining at least one subsequent quality score of each communication link of a plurality of communication links; determining that at least one subsequent quality metric of a third communication link exceeds at least one subsequent quality score of the second communication link, the third communication link being a lower priority than the second communication link; and in response to determining that the at least one subsequent quality score of the third communication link exceeds the at least one subsequent quality score of the second communication link, setting the third communication link as the active communication link for communicating data and communicating data over the third communication link.

Clause 6. The computer-implemented method of any one of Clauses 1-5, wherein the plurality of communication links includes at least one first communication link on a local area network (LAN) or wireless local area network (WLAN) and at least one second communication link on a wide area network (WAN), and wherein the LAN or WLAN is used to communicate with one or more other control and communication systems and the WAN is used to communicate with one or more external computing systems.

Clause 7. The computer-implemented method of Clause 6, wherein the at least one second communication link on the WAN includes a link shared by another control and communications system and not directly connected to the control and communications system.

Clause 8. The computer-implemented method of any one of Clauses 1-7, further including, at a third time: receiving an indication to override automatic switching of the active communication link from the first communication link to the second communication link; and in response to receiving the indication to override automatic switching of the active communication link, continuing to communicate data over the first communication link irrespective of the quality score of the second communication link exceeding the quality score of the first communication link.

Clause 9. The computer-implemented method of any one of Clauses 1-8, wherein determining the quality score of each communication link of the plurality of communication links includes combining one or more network performance metrics of each communication link.

Clause 10. The computer-implemented method Clause 9, wherein the one or more network performance metrics include at least one of latency, packet loss, jitter, download throughput, or upload throughput, and wherein determining the quality score of each communication link includes combining at least two of latency, packet loss, jitter, download throughput, or upload throughput.

Clause 11. The computer-implemented method of any one of Clauses 9-10, wherein determining the one or more network performance metrics of each communication link is performed by sending one or more pings to one or more network nodes.

Clause 12. The computer-implemented method of any one of Clauses 9-11, wherein determining the one or more network performance metrics of each communication link is performed periodically.

Clause 13. The computer-implemented method of any one of Clauses 1-12, further including outputting an identification of the active communication link on a user interface.

Clause 14. The computer-implemented method of any one of Clauses 1-13, further including, at the second time, outputting an indication on a user interface that the active communication link has been changed.

Clause 15. The computer-implemented method of any one of Clauses 1-14, further including outputting on a user interface the plurality of communication links in an order of ranked priority.

Clause 16. The computer-implemented method of any one of Clauses 1-15, further including at the second time: recording in an event log stored in a memory an event that indicates that the active communication link has been switched from the first communication link to the second communication link and time at which of the active communication link has been switched from the first communication link to the second communication link; and outputting the event log on a user interface.

Clause 17. The computer-implemented method of any one of Clauses 1-16, further including automatically characterizing at least some communication links of the plurality of communication links.

Clause 18. The computer-implemented method of any one of Clauses 1-17, wherein the plurality of communication links includes a cellular network link and a satellite network link.

Clause 19. The computer-implemented method of any one of Clauses 1-18, further including receiving, via a user interface, a ranking of priority of the plurality of communication links.

Clause 20. A system including: one or more computer-readable storage mediums configured to store program instructions; and one or more processors configured to execute the program instructions to cause the system to perform the computer-implemented method of any one of Clauses 1-19.

Clause 21. One or more computer-readable storage mediums configured to store program instructions, the program instructions executable by one or more processors to cause the one or more processors to perform the computer-implemented method of any one of Clauses 1-19.

Clause 22. A computer-implemented method for operating a control and communications system, the computer-implemented method including, by one or more processors executing program instructions: at a first time, outputting a main view of a user interface, the main view providing a first status of one or more power sources and a first status of one or more communication links and a plurality of secondary views accessible from the main view, and the user interface further including a plurality of secondary views accessible from the main view, the plurality of secondary views including: a power view that provides a second status of the one or more power sources, the second status of the one or more power sources including more status information than the first status of the one or more power sources; a communications view that provides a second status of the one or more communication links, the second status of the one or more communication links including more status information than the first status of the one or more communication links; a computing view that provides status of one or more computing systems; and a hardware view that provides status of a plurality of hardware systems along with their location, the plurality of hardware systems including first and second hardware systems, and the hardware view providing a first representation of the first hardware system that is operating normally and a second representation of the second hardware system that is operating incorrectly, the second representation being different from the first representation; and at a second time: receiving a user selection of a first secondary view from the plurality of secondary views; and in response to receiving the user selection of the first secondary view, outputting the first secondary view.

Clause 23. A computer-implemented method of Clause 22, wherein the user interface further includes a lock view, and wherein the computer-implemented method further includes, at a third time: determining that a threshold period of time during which no user input has been received at the user interface has elapsed; and in response to determining that the threshold period of time has elapsed, outputting a locked view that provides an alert that the second hardware system that is operating incorrectly.

Clause 24. The computer-implemented method of Clause 23, further including: receiving a user selection of a user interface component of the locked view; and in response to receiving the user selection of the user interface component, outputting a detailed view that provides information about the second hardware system.

Clause 25. The computer-implemented method of any one of Clauses 23-24, wherein the main view includes an indicator that the second hardware system is operating incorrectly.

Clause 26. The computer-implemented method of any one of Clauses 22-25, wherein the plurality of secondary views further includes a climate view that provides status of one or more climate control systems and an interface to adjust at least one climate control system of the one or more climate control systems.

Clause 27. The computer-implemented method of any one of Clauses 22-26, wherein the plurality of secondary views further includes a radio view that provides status of one or more radios and an interface to adjust operating parameters of the one or more radios.

Clause 28. The computer-implemented method of any one of Clauses 22-27, wherein the plurality of secondary views further includes an event view that outputs an event log including a plurality of events indicative of operation of at least one of: the one or more power sources, one or more communication links, one or more computing systems, or the plurality of hardware systems.

Clause 29. The computer-implemented method of Clause 28, wherein the event view includes one or more controls for filtering the plurality of events for output.

Clause 30. The computer-implemented method of any one of Clauses 22-29, wherein the communications view includes one or more controls for adjusting a level of electromagnetic (EM) emissions by one or more communication devices providing the one or more communication links.

Clause 31. The computer-implemented method of Clause 30, wherein adjusting the level of EM emission includes selecting a first EM emission level at which the one or more communication devices emit EM and a second EM emission level at which the one or more communication devices do not emit any EM.

Clause 32. The computer-implemented method of Clause 31, further including at a third time: receiving a user input at the one or more controls selecting the second EM emission level; and in response to receiving the user input selecting the second EM emission level, automatically disabling or turning off at least some of the one or more communication devices.

Clause 33. The computer-implemented method of Clause 32, further including at a fourth time: determining that a communication device of the one or more communication devices cannot be disabled or turned off automatically; and in response to determining that the communication device cannot be disabled or turned off automatically, outputting a notification that the communication device should be disabled or turned off by a user.

Clause 34. The computer-implemented method of any one of Clauses 22-33, wherein the main view and the plurality of secondary views include web-based graphical user interfaces.

Clause 35. The computer-implemented method of Clause 34, wherein the main view and the plurality of secondary views include a plurality of navigation tabs for selecting the main view and any secondary view.

Clause 36. The computer-implemented method of any one of Clauses 22-35, wherein the first and second representations include visual representations.

Clause 37. The computer-implemented method of any one of Clauses 22-36, wherein main screen and the plurality of secondary views each include a control for shutting down the control and communications system.

Clause 38. The computer-implemented method of Clause 37, further including at a third time: receiving a selection of the control for shutting down the control and communications system; in response to receiving the selection of the control, outputting a notification that the control and communications system is being shut down; and shutting down the control and communications system responsive to receiving a user confirmation.

Clause 39. The computer-implemented method of any one of Clauses 22-38, wherein the main view further provides a current time.

Clause 40. A system including: one or more computer-readable storage mediums configured to store program instructions; and one or more processors configured to execute the program instructions to cause the system to perform the computer-implemented method of any one of Clauses 22-39.

Clause 41. One or more computer-readable storage mediums configured to store program instructions, the program instructions executable by one or more processors to cause the one or more processors to perform the computer-implemented method of any one of Clauses 22-39.

Clause 42. A computer-implemented method for monitoring operation of control and communications systems, the computer-implemented method including, by one or more processors executing program instructions: receiving a plurality of metrics from a plurality of control and communications systems, the plurality of metrics indicating operational status of the plurality of control and communications systems over a plurality of periods of time; at a first time: receiving a request from a remote computing system for operational status of a first control and communications system of the plurality of control and communications systems; and in response to receiving the request for operational status of the first control and communications system, causing output on a user interface of a first plurality of metrics indicating operational status of the first control and communications system; at a second time: receiving a first user request to filter metrics indicating the operational status of the first control and communications system by a preset time period selectable through the user interface; and in response to receiving the first user request, causing output on the user interface of a second plurality of metrics indicating operational status of the first control and communications system during the preset time period; and at a third time: receiving a second user request to filter metrics indicating the operational status of the first control and communications system by a custom time period selectable through the user interface; and in response to receiving the second user request, causing output on the user interface of a third plurality of metrics indicating operational status of the first control and communications system during the custom time period.

Clause 43. The computer-implemented method of Clause 42, wherein the operational status of the first control and communications system includes status of communication links and services.

Clause 44. The computer-implemented method of Clause 43, wherein the first plurality of metrics includes a first communication link metric indicating that a first communication link is operating normally and a second communication link metric indicating that a second communication link is operating incorrectly, and wherein causing output on the user interface of the first plurality of metrics causes the first communication link metric to be output differently than the second communication link metric.

Clause 45. The computer-implemented method of Clause 44, wherein the first communication link metric is output in a different color than the second communication link metric.

Clause 46. The computer-implemented method of any one of Clauses 43-45, wherein the first plurality of metrics includes a first service metric indicating that a first service is operating normally and a second service metric indicating that a second service is operating incorrectly, and wherein causing output on the user interface of the first plurality of metrics causes the first service metric to be output differently than the second service metric.

Clause 47. The computer-implemented method of Clause 46, wherein the first service metric is output in a different color than the second service metric.

Clause 48. The computer-implemented method of any one of Clauses 42-47, wherein the operational status of the first control and communications system includes locations of the plurality of control and communications systems.

Clause 49. The computer-implemented method of any one of Clauses 42-48, further including, at a fourth time: receiving a request from the remote computing system for operational status of a second control and communications system of the plurality of control and communications systems; and in response to receiving the request for operational status of the second control and communications system, causing output on the user interface of a first plurality of metrics indicating operational status of the second control and communications system, wherein the plurality of control and communications systems group a fleet of control and communications systems.

Clause 50. The computer-implemented method of any one of Clauses 42-49, wherein the plurality of metrics from the plurality of control and communications systems are received periodically or in batches.

Clause 51. The computer-implemented method of any one of Clauses 42-50, further including: receiving a request to update software or firmware of the first control and communications system, the request indicating a type of software or firmware; and at a fourth time, in response to receiving the request to update software or firmware of the first control and communications system, transmitting an update bundle for the type of software or firmware to the first control and communications system and causing the first control and communications system to apply the update bundle.

Clause 52. The computer-implemented method of Clause 51, further including, at the fourth time: in response to receiving the request to update software or firmware of the first control and communications system along with a user selection to apply the update bundle and reboot, transmitting the update bundle for the type of software or firmware to the first control and communications system and causing the first control and communications system to apply the update bundle and subsequently reboot.

Clause 53. The computer-implemented method of any one of Clauses 51-52, further including, at a fifth time: in response to receiving the request to update software or firmware of the first control and communications system along with a user selection to not apply an update, transmitting the update bundle for the type of software or firmware to the first control and communications system and causing the first control and communications system to download but not apply the update bundle.

Clause 54. The computer-implemented method of any one of Clauses 42-53, further including: receiving a request to update software or firmware of the first control and communications system, the request indicating a type of software or firmware; and in response to receiving the request to update software or firmware of the first control and communications system, transmitting an update bundle for the type of software or firmware to the first control and communications system and causing the first control and communications system to store the update bundle in a repository for access by at least one other control and communications system.

Clause 55. The computer-implemented method of any one of Clauses 51-54, wherein the user interface includes a component configured to select a particular control and communications system from the plurality of control and communications systems for updating software or firmware.

Clause 56. The computer-implemented method of any one of Clauses 42-55, wherein causing output on the user interface of the first plurality of metrics indicating operational status of the first control and communications system causes output of the first plurality of metrics chronologically.

Clause 57. The computer-implemented method of any one of Clauses 42-56, wherein the user interface includes a component configured to select a particular control and communications system from the plurality of control and communications systems.

Clause 58. The computer-implemented method of any one of Clauses 42-57, further including performing at least one remedial action on the first control and communications system.

Clause 59. The computer-implemented method of any one of Clauses 42-58, wherein the user interface includes one or more web-based graphical user interfaces.

Clause 60. A system including: one or more computer-readable storage mediums configured to store program instructions; and one or more processors configured to execute the program instructions to cause the system to perform the computer-implemented method of any one of Clauses 42-59.

Clause 61. One or more computer-readable storage mediums configured to store program instructions, the program instructions executable by one or more processors to cause the one or more processors to perform the computer-implemented method of any one of Clauses 42-59.

Clause 62. A control and communications system including: a housing with a form factor of a tactical radio, the housing configured to be worn on a user's body or carried by a user; at least one connector supported by the housing and configured to connect at least one peripheral electronic device; a display supported by the housing; and an electronic processing circuitry configured to: operate the display to output information on the display; generate a user interface for operating the system and cause the at least one peripheral electronic device to output the user interface; establish a ranking of priority of a plurality of communication links, a first communication link of the plurality of communication links being assigned highest priority than any other communication links of the plurality of communication links; set the first communication link as an active communication link for communicating data; communicate data over the first communication link; determine that at least one quality metric of a second communication link of the plurality of communication links determined at a first time exceeds at least one quality metric of the first communication link determined at the first time; and in response to determining that at least one quality metric of the second communication link determined at the first time exceeds at least one quality metric of the first communication link determined at the first time, set the second communication link as the active communication link for communicating data and communicate data over the second communication link, wherein switching the active communication link from the first communication link to the second communication link is performed automatically.

Clause 63. The control and communications system of Clause 62, wherein the electronic processing circuitry is configured to: determine whether the at least one quality metric of the second communication link determined at the first time exceeds by at least a margin the at least one quality metric of the first communication link determined at the first time; in response to determining that the at least one quality metric of the second communication link determined at the first time exceeds by at least the margin the at least one quality metric of the first communication link determined at the first time, set the second communication link as the active communication link and communicate data over the second communication link; and in response to determining that the at least one quality metric of the second communication link determined at the first time does not exceed by at least the margin the at least one quality metric of the first communication link determined at the first time, continue communicating data over the first communication link.

Clause 64. The control and communications system of any one of Clauses 62-63, wherein the electronic processing circuitry is further configured to: determine that at least quality metric of the first communication link determined at a second time subsequent to the first time exceeds at least one quality metric of the second communication link determined at the second time; and in response to determining that the at least one quality metric of the first communication link determined at the second time exceeds the at least one quality metric of the second communication link determined at the second time, set the first communication link as the active communication link for communicating data and communicate data over the first communication link.

Clause 65. The control and communications system of any one of Clauses 62-64, wherein the plurality of communication links includes at least one communication link on a local area network (LAN) or wireless local area network (WLAN) and at least one communication link on a wide area network (WAN), and wherein the LAN or WLAN is used to communicate with one or more other control and communication systems and the WAN is used to communicate with one or more external computing systems.

Clause 66. The control and communications system of Clause 65, wherein the at least one communication link on the WAN includes a link shared by another control and communications system of the one or more other control and communication systems and is not directly connected to the control and communications system.

Clause 67. The control and communications system of Clause 66, wherein availability of the at least one communication link on the WAN is indicated on at least one of the display or the user interface.

Clause 68. The control and communications system of any one of Clauses 62-67, wherein the electronic processing circuitry is configured to communicate first data received from the at least one peripheral electronic device over the active communication link and provide to the at least one peripheral electronic device second data received over the active communication link.

Clause 69. The control and communications system of any one of Clauses 62-68, wherein the electronic processing circuitry is further configured to periodically determine at least one quality metric of each communication link of the plurality of communication links.

Clause 70. The control and communications system of any one of Clauses 62-69, wherein establishing the ranking of priority including receiving the ranking of priority.

Clause 71. The control and communications system of Clause 70, wherein the ranking of priority of the plurality of communication links is generated via one or more interaction of the user with the user interface and received from the at least one peripheral electronic device.

Clause 72. The control and communications system of any one of Clauses 62-71, wherein the at least one peripheral electronic device includes a first peripheral electronic device configured to output the user interface and a second peripheral device configured to monitor at least one physiological parameter of the user, and wherein the electronic processing circuitry is configured to transmit data indicative of the at least one physiological parameter over the active communication link.

Clause 73. The control and communications system of any one of Clauses 62-72, wherein the at least one connector includes a plurality of connectors supported by a top portion of the housing, and wherein a bottom portion of the housing supports a connector for a first battery.

Clause 74. The control and communications system of Clause 73, wherein the connector for the first battery includes a twist lock connector.

Clause 75. The control and communications system of any one of Clauses 73-74, wherein the connector for the first battery includes a connector for an MBITR compatible battery.

Clause 76. The control and communications system of any one of Clauses 73-75, wherein a connector of the plurality of connectors is configured to connect a second battery.

Clause 77. The control and communications system of any one of Clauses 62-76, wherein the housing includes a first heat sink supported by an exterior surface of the housing and a second heat sink supported by the exterior surface of the housing and positioned opposite the first heat sink.

Clause 78. The control and communications system of any one of Clauses 62-77, wherein the user interface includes a graphical user interface.

Clause 79. The control and communications system of any one of Clauses 62-78, wherein the at least one peripheral electronic device includes a heads-up display.

Clause 80. The control and communications system of Clause 79, wherein the display includes an electronic ink display.

Clause 81. A method for operating the control and communications system of any one of Clauses 62-80.

What is claimed is:

1. A computer-implemented method for operating a control and communications system, the computer-implemented method comprising, by one or more processors executing program instructions:
at a first time:
setting a first communication link of a plurality of communication links as an active communication link for communicating data, the first communication link being a highest priority communication link as compared to any other communication link of the plurality of communication links; and
communicating data over the first communication link; and
at a second time:
determining a quality score of each communication link of the plurality of communication links based on at least one quality metric of each communication link;
determining that a quality score of a second communication link of the plurality of communication links exceeds a quality score of the first communication link, the second communication link being a lower priority communication link than the first communication link; and
in response to determining that the quality score of the second communication link exceeds the quality score of the first communication link, setting the second communication link as the active communication link for communicating data and communicating data over the second communication link,
wherein switching the active communication link from the first communication link to the second communication link is performed automatically.

2. The computer-implemented method of claim 1, further comprising at the second time:
determining that the quality score of the second communication link exceeds by at least a margin the quality score of the first communication link; and
in response to determining that the quality score of the second communication link exceeds by at least the margin the quality score of the first communication link, setting the second communication link as the active communication link and communicating data over the second communication link.

3. The computer-implemented method of claim 1, further comprising at the second time:
determining that the quality score of the second communication link does not exceed by at least a margin the quality score of the first communication link; and
in response to determining that the quality score of the second communication link does not exceed by at least the margin the quality score of the first communication link, continuing to communicate data over the first communication link.

4. The computer-implemented method of claim 1, further comprising, at a third time subsequent to the second time:
determining at least one subsequent quality score of each communication link of a plurality of communication links;
determining that at least one subsequent quality score of the first communication link exceeds at least one subsequent quality score of the second communication link; and
in response to determining that the at least one subsequent quality score of the first communication link exceeds the at least one subsequent quality score of the second communication link, setting the first communication link as the active communication link for communicating data and communicating data over the first communication link.

5. The computer-implemented method of claim 1, further comprising, at a third time subsequent to the second time:
determining at least one subsequent quality score of each communication link of a plurality of communication links;
determining that at least one subsequent quality metric of a third communication link exceeds at least one subsequent quality score of the second communication link, the third communication link being a lower priority than the second communication link; and
in response to determining that the at least one subsequent quality score of the third communication link exceeds the at least one subsequent quality score of the second communication link, setting the third communication link as the active communication link for communicating data and communicating data over the third communication link.

6. The computer-implemented method of claim 1, wherein the plurality of communication links comprises at least one first communication link on a local area network (LAN) or wireless local area network (WLAN) and at least one second communication link on a wide area network (WAN), and wherein the LAN or WLAN is used to communicate with one or more other control and communication systems and the WAN is used to communicate with one or more external computing systems.

7. The computer-implemented method of claim 6, wherein the at least one second communication link on the WAN comprises a link shared by another control and communications system and not directly connected to the control and communications system.

8. The computer-implemented method of claim 1, further comprising, at a third time:
receiving an indication to override automatic switching of the active communication link from the first communication link to the second communication link; and
in response to receiving the indication to override automatic switching of the active communication link, continuing to communicate data over the first communication link irrespective of the quality score of the second communication link exceeding the quality score of the first communication link.

9. The computer-implemented method of claim 1, wherein determining the quality score of each communication link of the plurality of communication links comprises combining one or more network performance metrics of each communication link.

10. The computer-implemented method of claim 9, wherein the one or more network performance metrics comprise at least one of latency, packet loss, jitter, download throughput, or upload throughput, and wherein determining the quality score of each communication link comprises combining at least two of latency, packet loss, jitter, download throughput, or upload throughput.

11. The computer-implemented method of claim 9, wherein determining the one or more network performance metrics of each communication link is performed by sending one or more pings to one or more network nodes.

12. The computer-implemented method of claim 9, wherein determining the one or more network performance metrics of each communication link is performed periodically.

13. The computer-implemented method of claim 1, further comprising outputting an identification of the active communication link on a user interface.

14. The computer-implemented method of claim 1, further comprising, at the second time, outputting an indication on a user interface that the active communication link has been changed.

15. The computer-implemented method of claim 1, further comprising outputting on a user interface the plurality of communication links in an order of ranked priority.

16. The computer-implemented method of claim 1, further comprising at the second time:
recording in an event log stored in a memory an event that indicates that the active communication link has been switched from the first communication link to the second communication link and time at which of the active communication link has been switched from the first communication link to the second communication link; and
outputting the event log on a user interface.

17. The computer-implemented method of claim 1, further comprising automatically characterizing at least some communication links of the plurality of communication links.

18. The computer-implemented method of claim 1, wherein the plurality of communication links comprises a cellular network link and a satellite network link.

19. The computer-implemented method of claim 1, further comprising receiving, via a user interface, a ranking of priority of the plurality of communication links.

20. A control and communications system comprising:
one or more computer-readable storage mediums configured to store program instructions; and
one or more processors configured to execute the program instructions to perform the computer-implemented method of claim 1.

21. The control and communications system of claim 20, further comprising:
a housing with a form factor of a tactical radio, the housing configured to be worn on a user's body or carried by a user;
at least one connector supported by the housing and configured to connect at least one peripheral electronic device;
a display supported by the housing; and
an electronic processing circuitry configured to:
operate the display to output information on the display;
generate a user interface for operating the system and cause the at least one peripheral electronic device to output the user interface.

22. One or more computer-readable storage mediums configured to store program instructions, the program instructions executable by one or more processors to cause the one or more processors to perform the computer-implemented method of claim 1.
